(19) United States
(12) Patent Application Publication
(10) Pub. No.: US 2014/0074506 A1
(43) Pub. Date: Mar. 13, 2014

(54) Health Information Management System

(71) Applicants: Matthew James Oliver, Toronto (CA); Robert Ross Quinn, Calgary (CA)

(72) Inventors: Matthew James Oliver, Toronto (CA); Robert Ross Quinn, Calgary (CA)

(21) Appl. No.: 13/683,823

(22) Filed: Nov. 21, 2012

Related U.S. Application Data
(63) Continuation-in-part of application No. 12/363,583, filed on Jan. 30, 2009, now abandoned.

(51) Int. Cl. G06F 19/00

(52) U.S. Cl. CPC G06F 19/322
USPC 705/3

(57) ABSTRACT

A server device, and related systems and methods for managing dialysis patient information. The patient information includes information relating to stages of data collection including baseline characteristics, eligibility for treatment modalities, and outcomes. A remote terminal is configured for displaying in the remote terminal a first user interface for receiving the patient information for the subject patient. The server is configured to receive from the remote terminal the patient information for the subject patient and store said patient information in a patient record in the memory, and determine, based on medical logic rules, whether the patient information is consistent with the patient record in order to proceed to a next stage of data collection, and if so permitting displaying in the remote terminal a second user interface for receiving patient information relating to the next stage of data collection.

### FIELD OF INVENTION

This invention relates generally to health information systems. This invention relates more particularly to computer network enabled systems for promoting health information quality.

### BACKGROUND OF INVENTION

Governments, insurance companies, and administrators are increasingly demanding accountability in funding healthcare. In order to implement accountability in healthcare it is often necessary to ensure that appropriate processes and systems are in place to ensure that there is data quality.

Some systems and solutions are known for providing data quality. Some healthcare information systems incorporate processes or utilities for promoting healthcare information quality. For example, some clinic management systems enable users to fill in patient information, including in part to provide accountability regarding health services provided and outcomes thereof. Such prior art systems are time consuming to use, and usually require the hiring of data entry staff. Also, some information needs to be provided or confirmed by medical staff. Prior art systems require data entry staff to solicit and follow up with information requirements with medical staff manually. Also prior art systems do not include mechanisms for streamlining processes for assuring data quality.

An improved system is provided for promoting information quality, and thereby improving accountability in collection and management of health information.

A skilled reader will appreciate that an improve health information quality platform has many applications. One application of the health information management system of the present invention is in relation to capture of validate dialysis information.

For example population-based studies would suggest that between 5% and 16% of the adult population in North America has some form of chronic kidney disease. The Canadian Organ Replacement Register (CORR) reported that there were nearly 30,000 patients with kidney failure being treated by either dialysis or transplant in Canada in 2002, up 55% compared to a decade earlier. Caring for patients with kidney failure is resource intense and the health care costs generated by this segment of the population constitutes up to 7% of total health care expenditures in developed countries. In the United States, as of 2004, approximately 8% of adults aged 20 or older have physiological evidence of chronic kidney disease.

There are currently three main treatment options available to patients with kidney failure: transplantation, hemodialysis, and peritoneal dialysis. Donor kidneys are a generally a scarce resource and as such the great majority of patients would have to choose between hemodialysis and peritoneal dialysis. Hemodialysis generally requires bulky equipment including a hemodialysis machine, and generally may be limited to within a hospital-type treatment facility. On the other hand, peritoneal dialysis may be implemented off-site, and even performed by the patient him/herself in the home of the patient.

As there may be numerous patient records for a given site, or multiple sites, it may be difficult to obtain research-quality data, and maintain uniform and scaleable information. In addition, multiple parties may be involved in the treatment process, including nurses, doctors, technicians, patients, etc. This is typically recorded by way of patient charts, which may be difficult to maintain and/or compare as between multiple parties, and especially when considering multiple facilities.

Some conventional electronic medical record (EMR) databases are available which provide for a mass storage bank of patient information. However, it is difficult to maintain accuracy of information in some of these systems because of the volume and scale of the patient information. A user may enter data from a patient chart incorrectly, and such errors may be ascertained too late, or not at all. Maintaining accurate information is of high importance when determining patient outcomes on different types of dialysis therapies.

There is a need for an improved health information quality management system and associated computer network implemented methods to address the mentioned disadvantages.

### SUMMARY OF INVENTION

According to example embodiments, there is provided an information management system for determining whether patient information relating to a stage of data collection is consistent with logic rules in order to proceed to a next stage of data collection.

According to one example embodiment, there is provided a method for managing dialysis patient information of a subject patient in an information management system. The information management system includes a server device having a memory for storing of patient records and a remote terminal in communication with the server device over a network, the patient information including information relating to stages of data collection including baseline characteristics, eligibility for treatment modalities, and outcomes. The method includes: displaying in the remote terminal a first user interface for receiving patient information relating to a specified stage of data collection for the subject patient, the first user interface including a plurality of variable-specific user input fields related to variables; receiving in the server device from the remote terminal the patient information for the subject patient and storing said patient information in a patient record in the memory of the server device; and determining, based on medical logic rules, whether the patient information is consistent with the patient record in order to proceed to a next stage of data collection, and if so permitting displaying in the remote terminal a second user interface for receiving patient information relating to the next stage of data collection.

According to another example embodiment, there is provided a server device for managing dialysis patient information of a subject patient, the patient information including information relating to stages of data collection including baseline characteristics, eligibility for treatment modalities, and outcomes, the server device being in communication with a remote terminal over a network, the remote terminal being configured for displaying in the remote terminal a first user interface for receiving the patient information for the subject patient, the first user interface including a plurality of variable-specific user input fields related to variables. The server device includes: a controller; a memory accessible by the controller for storing of patient records; the controller being configured to receive from the remote terminal the patient information for the subject patient and store said patient information in a patient record in the memory; and the controller being configured to determine, based on medical logic rules, whether the patient information is consistent with the patient record in order to proceed to a next stage of data collection, and if so permitting displaying in the remote terminal a second user interface for receiving patient information relating to the next stage of data collection.

According to another example embodiment, there is provided an information management system for managing dialysis patient information of a subject patient, the patient information including information relating to stages of data collection including baseline characteristics, eligibility for treatment modalities, and outcomes. The information management system includes: a server device having a memory for storing of patient records; a remote terminal in communication with the server device over a network; wherein the remote terminal is configured to display a first user interface for receiving patient information relating to a specified stage of data collection for the subject patient, and send to the server device the patient information for the subject patient, the server device storing said patient information in a patient record in the memory of the server device; and wherein the server device is configured to determine, based on medical logic rules, whether the patient information is consistent with the patient record in order to proceed to a next stage of data collection, and if so permitting displaying in the remote terminal a second user interface for receiving patient information relating to the next stage of data collection.

In some example embodiments, logic rules includes: completeness, wherein missing values which are medically relevant are flagged; validity, wherein data is out of range; timing of events, wherein medical events in patients with kidney disease follow a valid temporal sequence; content and consistency of data, wherein values of variables within the system does not conflict with one or more other values of variables; unknown values, wherein the system identifies data which is coded as unknown and provides targeted education back the user to help resolve the unknown value for variables that require judgement or interpretation to reduce subjectivity.

### BRIEF DESCRIPTION OF THE DRAWINGS

Example embodiments will now be described by way of example with reference to the accompanying drawings, through which like reference numerals are used to indicate similar features.

FIG. 1A shows a block diagram of an example of a patient information management system in accordance with example embodiments;

FIG. 1B is a further block diagram illustrating the logic system of the present invention in accordance with an example embodiment;

FIG. 2 shows a block diagram of a server device to be used in the information management system shown in FIG. 1A;

FIG. 3 shows a flow diagram implemented by the server device of FIG. 2;

FIG. 4 shows a diagrammatic view of an example graphical user interface for a remote terminal in the system of FIG. 1A, showing a custodian inbox page for a principal investigator for baseline information;

FIG. 5 shows a diagrammatic view of an example graphical user interface for a remote terminal in the system of FIG. 1A, showing a custodian report page for a specified centre with respect to those patient records in the baseline stage of data collection;

FIG. 6 shows a diagrammatic view of an example graphical user interface for a remote terminal in the system of FIG. 1A, showing a custodian report page for the present user with respect to those patient records in the inclusion/exclusion stage of data collection;

FIG. 7 shows a diagrammatic view of an example graphical user interface for a remote terminal in the system of FIG. 1A, showing a patient registration page;

FIG. 8 shows a diagrammatic view of an example graphical user interface for a remote terminal in the system of FIG. 1A, showing an edit patient registration information page;

FIG. 9 shows a diagrammatic view of a graphical user interface for the remote terminal in the system of FIG. 1A, showing an inclusion/exclusion criteria form;

FIGS. 10A and 10B each shows a portion of a diagrammatic view of a graphical user interface for the remote terminal in the system of FIG. 1A, showing a baseline form for dialysis information;

FIG. 11 shows a diagrammatic view of a query message box for changing a variable in the baseline form of FIG. 10A or 10B;

FIG. 12 shows a diagrammatic view of another query message box in response to the query message box of FIG. 11;

FIG. 13 shows a diagrammatic view of another query message box in response to the query message box of FIG. 12;

FIG. 14 shows a diagrammatic view of another query message box in response to the query message box of FIG. 13;

FIGS. 15A and 15 B each shows a portion of a diagrammatic view of a graphical user interface for the remote terminal in the system of FIG. 1A, showing a baseline form for comorbidity information;

FIGS. 16A,16B, 16C and 16D each shows a portion of a diagrammatic view of a graphical user interface for the remote terminal in the system of FIG. 1A, showing a baseline form for treatment eligibility information;

FIG. 17 shows a diagrammatic view of a graphical user interface for the remote terminal in the system of FIG. 1A, showing a longitudinal form for patient education;

FIG. 18 shows a diagrammatic view of a graphical user interface for the remote terminal in the system of FIG. 1A, showing a longitudinal form for changes in treatment status;

FIG. 19 shows a diagrammatic view of a graphical user interface for the remote terminal in the system of FIG. 1A, showing a longitudinal form for hospitalization;

FIG. 20 shows a diagrammatic view of a graphical user interface for the remote terminal in the system of FIG. 1A, showing a longitudinal form for access related interventions;

FIGS. 21A and 21B each shows a portion a diagrammatic view of a graphical user interface for the remote terminal in the system of FIG. 1A, showing a patient information tracker page for a subject patient;

FIG. 22 shows a diagrammatic view of an example graphical user interface for the remote terminal in the system of FIG. 1A, showing a message box for transferring access of a patient record, accessible from the tracker page of FIGS. 21A and 21B;

FIG. 23 shows a diagrammatic view of an example graphical user interface for the remote terminal in the system of FIG. 1A, showing a view registered patient page;

FIG. 24 shows another data table resulting from the information obtained from the server terminal in the system of FIG. 1A, showing modality choice information;

FIG. 25 shows another data table resulting from the information obtained from the server terminal in the system of FIG. 1A, showing demographic, comorbidity, and laboratory information;

FIG. 26 shows another data table resulting from the information obtained from the server terminal in the system of FIG. 1A, showing baseline information;

FIGS. 27A and 27B each shows a portion of another data table resulting from the information obtained from the server terminal in the system of FIG. 1A, showing multidisciplinary assessment information; and

FIG. 28 shows a data table resulting from the information obtained from the server terminal in the system of FIG. 1A, showing a query report.

FIG. 29 an illustration of the key functions of the present invention.

FIG. 30 illustrates the redistribution based on changes to a “site”.

FIGS. 31-33 illustrate possible screens presented by the computer system of the present invention for enabling custodians to complete “tasks”.

### DETAILED DESCRIPTION

### Definitions

“Custodian” refers to a user of the system of the present invention, to whom “tasks” as defined below have been assigned by the system, which relate to data entry/correction/validation. Some of the embodiments of the invention described herein refer to a “principal investigator” which is a type of “custodian”.

“Administrator” refers to an administrative user of the system of the present invention, who administers data entry/correction/validation tasks, or projects comprising a plurality of tasks.

### General System

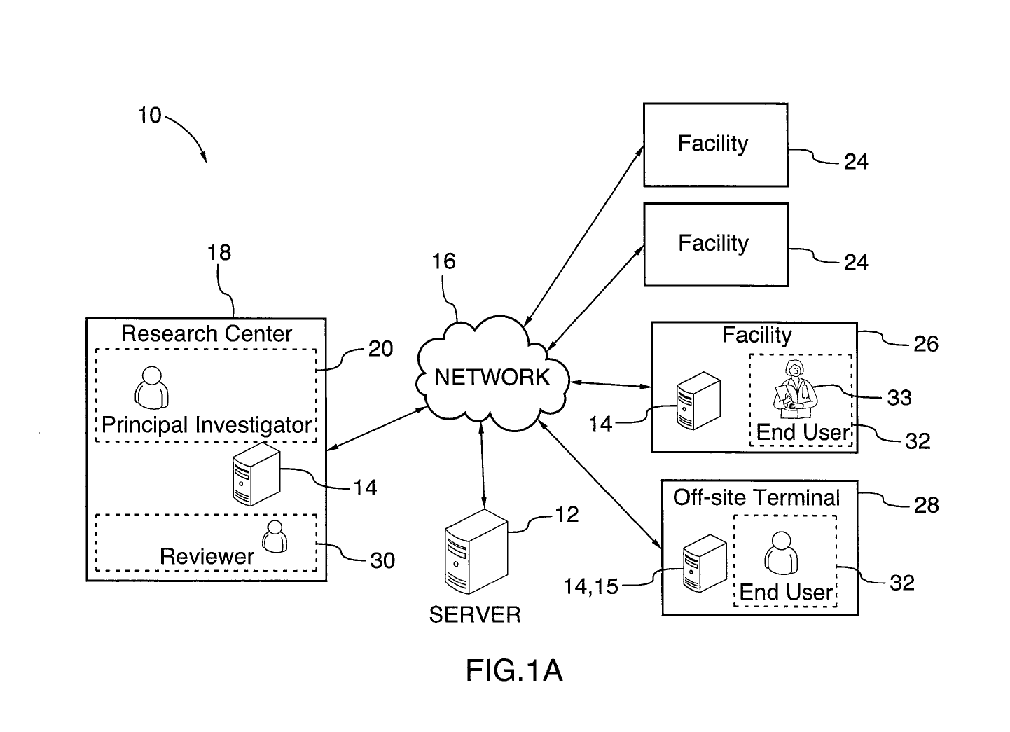

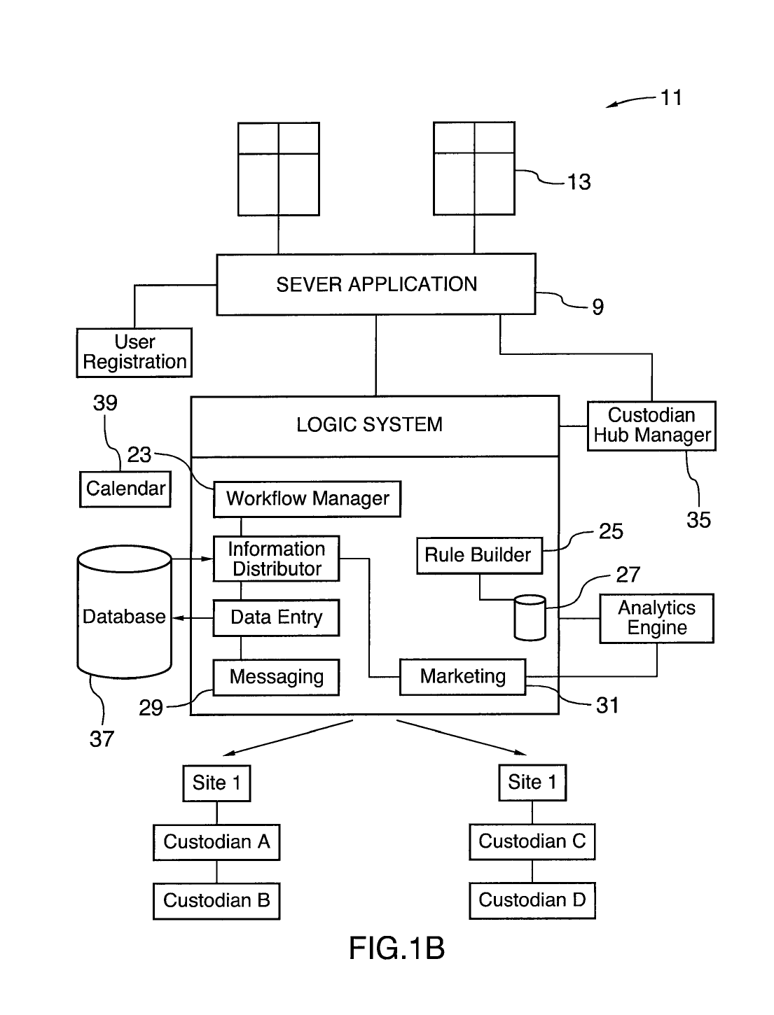

Reference is now made to FIG. 1A, which shows a patient information management system 10 in accordance with example embodiments. A main server device 12 may be used for control of the system 10 and to store and access patient information, for example stored as patient records in a patient database. The server device 12 may be accessed by remote terminals 14, which may be conventional personal computers each having a display screen, user input such as a keyboard and mouse, a connection to network 16, a processor, and a web-based browser installed thereon for communication over the network 16. The network 16 may include the Internet, wired or wireless networks, enterprise networks, local area networks, one or more wireless local area networks (WLAN), or for example networks compliant with one or more of the IEEE 802x family of standards.

As shown, a research centre 18 may have a principal investigator 20 who is responsible for maintaining of the patient database, as well as the accuracy of the patient information. Research may be performed in facilities such as the research centre 18 as well as in a number of other locations, for example in external facilities 22, 24, 26 as well as off-site 28 (such as in a residence of a patient). The off-site 28 terminal may further be in communication with facility 26, for example using a virtual private network (VPN), to access the server 12. Thus, each facility may be geographically separated. Reference to a “facility” may also represent a region or a number of facilities, as appropriate. Each facility may include a reviewer 30 who has responsibility for higher-level operations. Although the reviewer 30 is shown as a separate person located within the research centre 18, the reviewer 30 may in some embodiments be anyone who is responsible for approving data when received by the research centre 18. The reviewer 30 may for example be the principal investigator 20, a medical director, a nursing manager etc. Each facility may also have an end user 32 (e.g. shown as a nurse 33 or nurses), who may be responsible for the actual care of the patient and measuring/determining of patient information to be entered into the patient database of the server device 12 using the remote terminals 14. The end user 32 may also access the server device 12 using an off-site terminal 15. Each facility should have at least one end user 32 who is trained in the use of the remote terminal 14. Depending on the access rights, the principal investigator 20, the reviewer 30 or the end user 32 can input patient information to the server device 12 using the remote terminals 14. Although reference may be made herein to “local” and “remote” with respect to the server device 12, in some example embodiments the server device 12 may in fact be located within the research centre 18 or one of the facilities.

### Logic System

HIQMS (Health Information Quality Management System) is a computer network enabled system 11 (may also be referred to as the “platform” 11 herein) that provides one or more Internet utilities for collecting information from multiple locations, and storing this information to a central database 37. A particular embodiment of the system 11 is illustrated in FIG. 1B.

Also as best illustrated in FIG. 1B, in one implementation of the present invention the HIQMS consists of one or more server computers 13, which may also be implemented as a server farm. Server computer 13 may be linked to a server application 7, that includes or is linked to a series of computer program utilities for providing the health information quality solution of the present invention.

A skilled reader will understand that the system 11 may be implemented using various different computer network architectures. For example, the server computer 13 and features of the server application 15 may be implemented as part of a cloud service.

In one aspect of the present invention, the system 11 includes a logic system 17 that includes one or more utilities that execute a series of processes for the data quality of the health information. The system 11 implements a series of innovative workflows for providing improved data quality for health information, as explained herein.

In one aspect of the invention, the logic system 17 executes one or more processes that enable the intelligent delegation of data entry, correction, and/or validations tasks to a plurality of custodians 9. Significantly, two or more sites are generally associated with the logic system 17, and each site may include a plurality of personnel who may be registered to the system 11 to fulfill data entry/correction/validation tasks (may be referred to as “tasks”). As further explained below, the system 11 delegates these tasks on an intelligent basis based on a number of criteria that depend on (A) the particular health information, (B) associated data quality standards or objectives (“data quality standards”), (C) suitability of selected custodians based on the data quality goals, as applied to particular health information. For example, as explained in greater detail below, the system 11 enables the definition of particular data quality parameters relevant to health information.

These rules may include:
(A) preferring the assignment of tasks to custodians that are in the same location as a patient, because they are likely to have ready access to relevant information, including based on asking questions from other staff members at a site;
(B) assigning tasks based on relative performance of the custodian in connection with similar tasks, and optionally based on the data quality standards; and/or
(C) current workload.

A skilled reader will understand that other rules are possible.

The logic system 17 includes functionality for using the rules to assign tasks on an intelligent basis. Certain assignment processes may be executed by the logic system 17 automatically, and others may be assigned by a decision support layer that may be presented for example to a system administrator. The server application 7 may execute a decision support utility that may include one or more screens that suggest task assignment options, and associated relevant information, and enable administrators to approve suggestions or make decisions regarding task assignments in a way that promotes execution relative data quality standards in an efficient manner.

A key insight of the system 11 and associated workflows is the need to provide a flexible system where that allows (A) the monitoring of performance relative to data quality parameters, including using a series of reporting tools that may use output from the analytics engine so as to provide information relevant to an administrator for reconfiguring rules of the logic system; (B) use of the rule builder 25 to dynamically reconfigure rules, using a rules database library, so as to iteratively and dynamically improve configuration of the system so as to achieve data quality standards; (C) reconfiguration of rules to respond to changes that can affect performance relative to data quality standards such as for example (i) changes in staff; (ii) changes in data quality standards for example based on regulatory or reporting changes; (iii) changes in commitment level of particular custodians; (iv) changes in resources available for data entry/correction/validation; or (v) other factors. A skilled reader will appreciate that where data capture/correction/validation occurs across two or more sites, managed by one or more administrator who may or may not be located at either of these sites, the administrator may not have knowledge of such changes. However, based on the design of the logic system 17, and also the analytics engine 33 that is configured to permit the discovery of information and insights that are relevant to maintaining data quality standards, or creating and achieving new data quality standards, administrators may react to such changes by making adjustments either based on processes automated by the system 11 (for example automated reallocation of tasks that address the changes) or based on decisions of administrators using the decision supports functions of the logic system 17.

In another aspect of the present invention, the server application 7 includes a user registration utility 19 that may include standard features and functions for registering various users to the system, including based on managed permissions. For example, the user registration utility 19 may be used to establish administrator and custodians on the system 11, along with various parameters of their profiles. In another aspect, different entities such as clinics or hospitals may be established on the system 11 using the user registration utility, as well as optionally specific patients, in part to establish rules for accessing information, including to maintain confidentiality and privacy of information. A skilled reader will understand that the user registration utility 19 may include or may be linked to various tools or platforms for providing information security and privacy.

As previously stated, a key aspect of the present invention is the functionality provided by the logic system 17 wherein the a user such as an administrator may configure, including on an iterative basis, the various rules associated with the establishing and maintaining the data quality standards. In one implementation, the logic system 17 includes a rule builder 25 that enables users such as administrators to build data quality related rules, using for example a set of rules stored to a rules library 27. In one implementation, the rule builder is similar to rule builders in other systems, wherein an interface is provided where an administrator can construct sets of rules by selecting rules and joining these to construct data quality related processes by building associated rule sets. The rule builder 25 may include an adaptive interface that based on an entity's health information and entity profile suggests relevant rules and may also utilize the analytics engine 33 may suggest ways in which to modify rule sets to improve performance relative to data quality standards. A skilled reader will appreciate that the system 11 may be configured or extended in variety of ways to build on the intelligent system features described.

In one aspect of the invention, a workflow manager 23 is provided that, based on applicable rule sets, and available custodians 9 may allocate particular tasks to particular custodians in an intelligent manner as suggested above.

In one aspect of the workflow manager 23, the system 11 or for example an administrator may define or retrieve one or more tasks for completion.

The workflow manager 23 in one aspects accesses or generates information regarding available custodians. Availability information may be extracted for example from one or more calendar 39 that may be linked to the system 11.

As stated previously, the custodians may be at two or more locations, as shown in FIG. 1B. The workflow manager 23 may then invoice the matching utility 31. The matching utility 31 may in turn invoke the analytics engine 33, for example to access one or more algorithms for determining an efficient allocation of tasks between multiple custodians, and optionally across multiple allocations, so as to improve likely performance relative to applicable data quality standards based on the particular allocation. A skilled reader will understand that the analytics engine 33 may include or embody various different algorithms such as decision making, decision “optimization” algorithms and the like.

In one aspect, the matching utility 31 returns a list of custodians and parameters for allocating one or more tasks to two or more custodians.

In one aspect of the invention, the information distributor 37 may extract information required to allocate tasks to particular custodians. This information may be provided to the messaging utility 29. The messaging utility 29 may consist for example of a utility or Internet service that is operable to send a communication or notification to custodians such as an invitation to open a link or access an email that includes information related to a task and for example one or more fields that solicit completion by custodians of their assigned tasks.

The messaging utility 29 may for example present an in-box that includes tasks allocated by the system 11. The in-box may include for example particulars of the task; start date; due date; number of days that a task is overdue and so on. A custodian may use the object in the inbox in order to access a computer program or Internet screen for providing the information required. In one implementation of the system 11, the logic system 17 includes a data entry utility which may be linked to the messaging utility 29, and that enables custodians to enter data/correct data/or validate data (other processes relevant to data entry and data quality may also be included).

The information provided/correction of data/or validation of data may then be logged by the logic system 17 to the database 37.

A skilled reader will understand that the database 37 may be implemented in a number of ways, for example as network of database, a multi-location data centre, a peer-to-peer data service and so on.

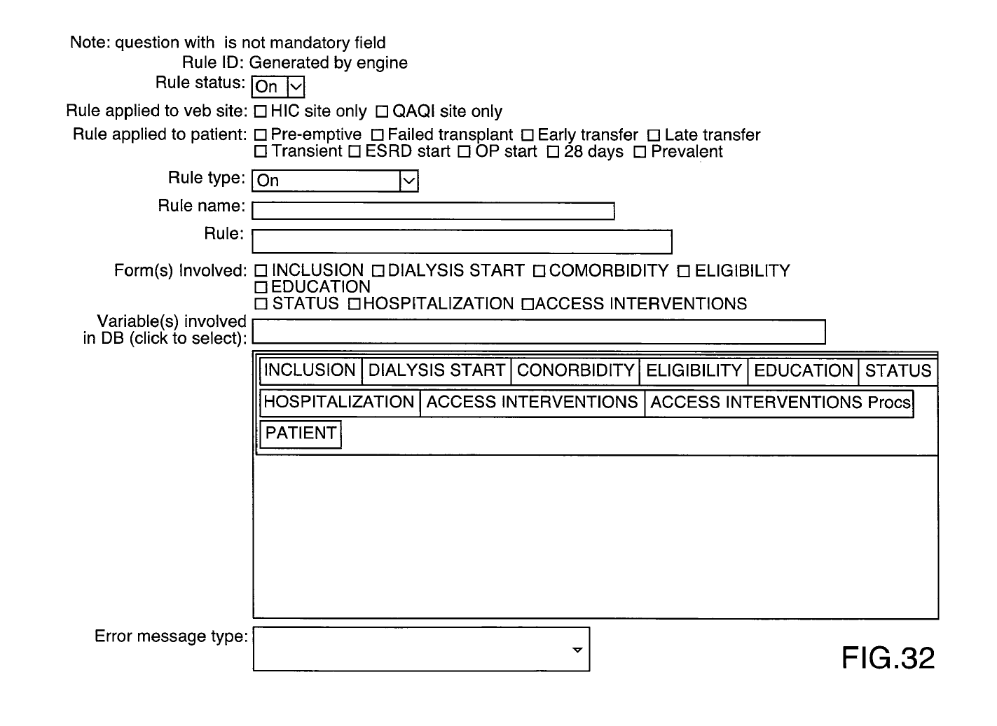

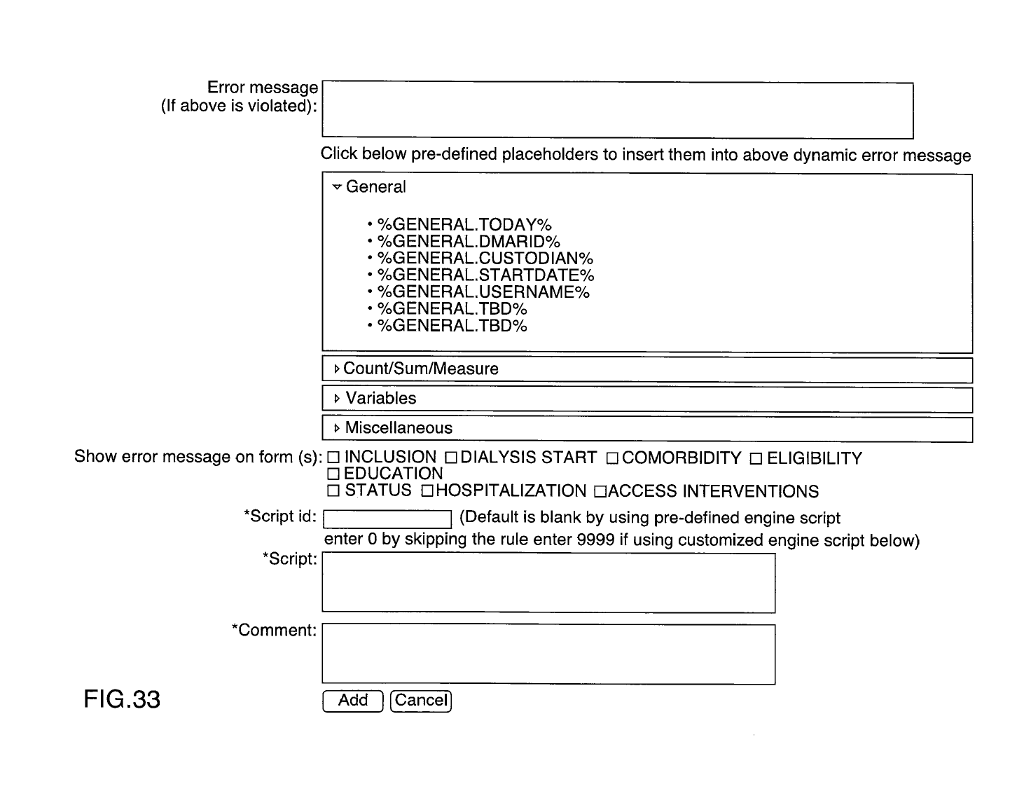

FIGS. 32 and 33 illustrate possible implementations of the system 11 wherein a screen is displayed for custodians that include for example (A) tabs representing different categories of information to be provided/corrected/validated; (B) display of associated rules, or a summary of applicable rules; and (C) optionally suggestions for completing tasks, including links to documentation for assisting custodians in completing tasks.

The workflow manager 23 may be implemented using functionality or screens similar to other workflow managers. For example, the workflow manager 23 may include a series of tools for viewing open tasks and completed tasks; available resources (such as information regarding availability of custodians); various reports regarding degree of completion of tasks, or projects comprising a multiplicity of tasks; tools for enabling collaboration between administrators and optionally different entities in connection with tasks or projects. A skilled reader will understand that various other features or functions are possible.

In one particular aspect of the invention, the logic system 17 may allocate particular patients to one or more custodians who are a good match for providing information or correcting or validating information related to a particular patient. For example the custodian may be nurse who knows a particular patient. The logic system 17 may also extract information from other databases such a clinic information systems so as to support matching operations of the matching utility 31.

One insight of the inventors is that data quality improves where the custodian for records relevant to a patient is somebody who “knows” the patient. They have more ready access to information. Also, they are likely to “care about” the particular patient; the particular patient is not just a record number to them. The custodian in these circumstances is more likely to complete relevant tasks in a way that meets data quality standards. One insight of the system 11 is the relationship between data quality and allocation of tasks in this way. A further insight is how to build a computer network enabled platform that spans different sites and enables managed information capture/correction/validation in a way that is efficient and scalable. A further insight is the design of the system 11 in a way that this managed information capture/correction/validation occurs in an intelligent way. A still further insight is the design of the system 11 that includes certain automated processes, and in other respects decision support processes.

In another aspect of the invention, the workflow manager 23 may access up to date information regarding availability of custodians so as to dynamically assign tasks based on down times or less busy times of personnel who play other roles, in order to utilize them efficiently and effectively as custodians. Further details in this regard are explained below.

A skilled reader will also appreciate that the present invention may consist of an Internet enabled managed crowd source platform, where a crowd of custodians and their activities related to information capture/correction/validation are managed using a set of crowd management utilities. The system 11 may include or link to various tools, or may embody various processes, used in a variety of crowd source platforms.

A skilled reader will appreciate that the system 11 executes a custodian hub manager 35. A community of custodians may be managed by the system 11. The custodian hub manager 35 may include various functions for training custodians; rewarding custodians for meeting data quality objectives (including using gamification or an incentive platform); monitoring custodian performance; assigning specific tasks completed by particular custodian to one or more audit processes. Auditing may include verification by an administrator or supervisor for example of particular work of a custodian, automated correction of information, automated escalation of detected errors, and so on.

A skilled reader will understand that the system 11, and the processes and workflows embodied therein, constitutes an improvement over the prior art in that accountability in relation to health information is improved significantly. Accountability is improved if for example clinically meaningful data can be collected accurately about health care delivery and patient outcomes. Based on prior art solutions, most data used for accountability is derived from large administrative databases or registries with variable data quality. Data quality may be poor because the data was not collected originally for the purposes of performance measurement (e.g. financial data). The volume of data may also be too large to undergo meaningful centralized review to maintain standards across health care organizations. Standardization across organizations is very important if performance is going to be benchmarked, judged, and rewarded. For example, the Ontario Renal Network collects approximately 10,000 patient records per month related to dialysis patients. These records may be checked for missing values, out of range values etc. but it is not feasible to ensure the data “makes sense” clinically and accurately represents the medical history of the patients, using prior art solutions and approaches. Review by medical experts would be required to maintain this data quality which in the current state is not scalable at reasonable cost.

In contrast, clinical trials maintain very high data quality. Data is collected by highly trained research coordinators with protected time. Every piece of data is reviewed centrally by a skilled central coordinator. The Principal Investigator and local site investigators are available to resolve data queries that cannot be handled by coordinators. Data of poor quality is corrected through this extensive review process. The end result is data of that meets the very high standards of licensing bodies (e.g. Federal Drug Administration) and prestigious peer reviewed medical journals (e.g. New England Journal of Medicine).

In effect, the system 11 enables the collection of high quality data similar to that collected in connection with clinical trials, except in accordance with the present invention this is made possible for large populations, and in a cost effective and scalable way.

A skilled reader will also appreciate that the present invention may also be applied for various other uses, such as by adapting the system to streamline the collection of information in connection with clinical trials.

Various applications of the system 11 are possible. Below is described for example the use of the system of the present invention as an adverse event tracking system for dialysis patients. A skilled reader will appreciate that certain of the steps or processes described below may be automated or streamlined using the logic system 17 described herein. The logic system 17 enables large amounts of health care data to be collected with very high quality. A skilled reader will also understand that the system 11 may be used to collect/correct/validate any form of health care data but the advantages of the system are illustrated by referencing the example of development of a dialysis database, as one possible embodiment of the present invention.

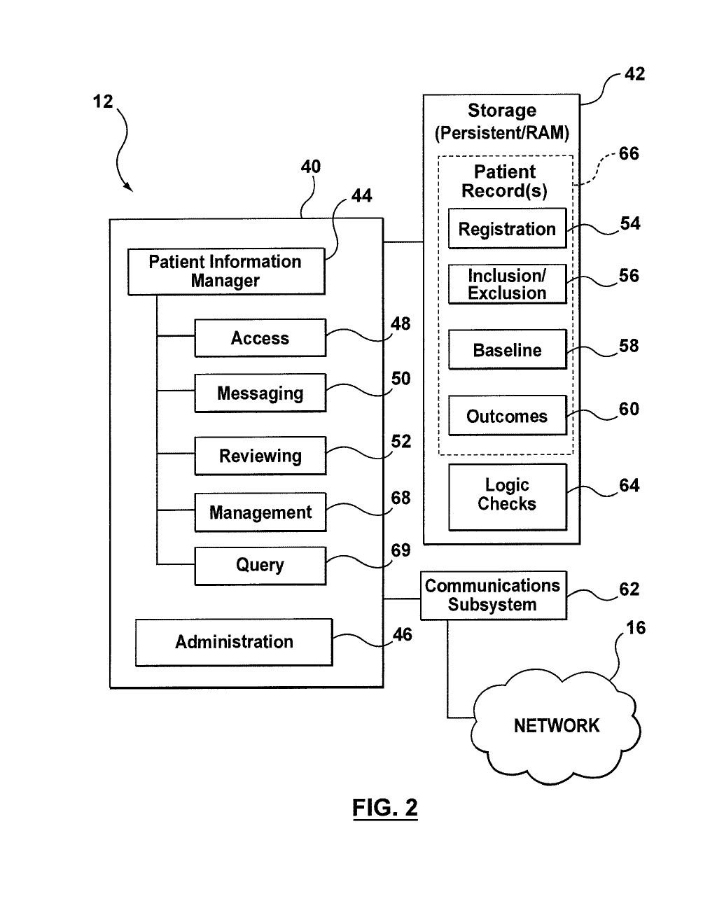

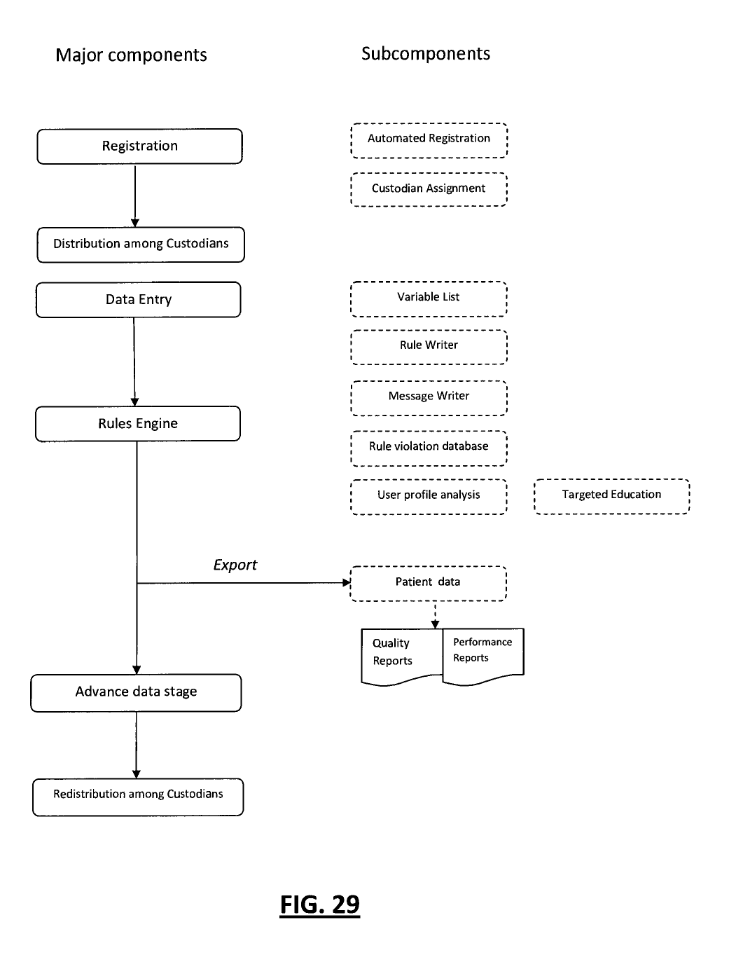

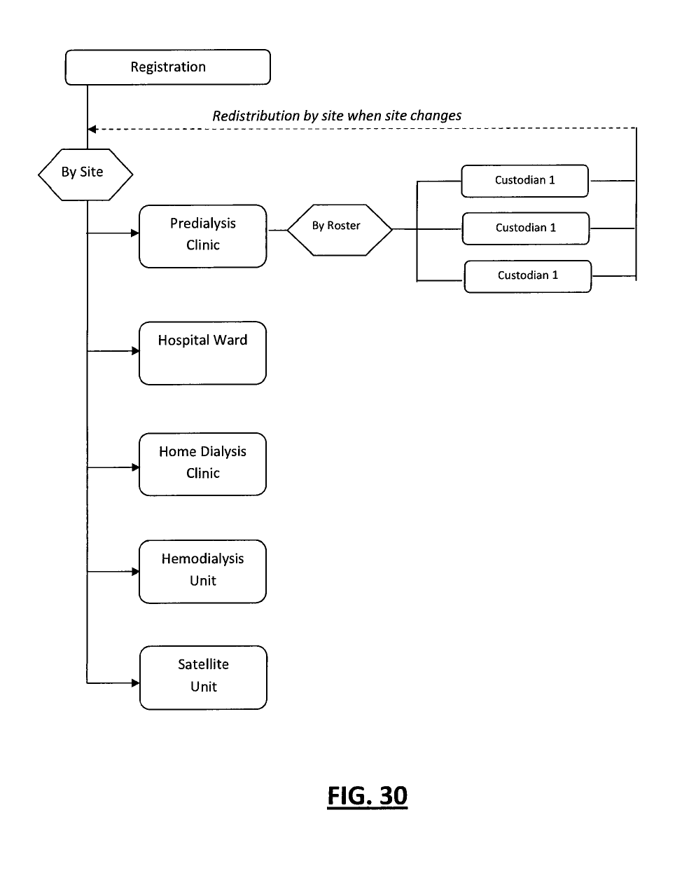

FIG. 1B refers to a rule builder 25. This may be implemented as a rules engine, for example as illustrated in FIG. 29. The rules engine in one possible embodiment of the present invention, which is also shown in FIG. 2 may be implemented as an administrative system that allows the data reviewers (such as administrators) to program rules (FIG. 33). It may be implemented such that includes the following components.
a) Variable list—that may include all objective variables (binary, continuous, categorical, dates) in the database that will be used to build rules. The variables can be organized by the data entry form (e.g. baseline information, hospitalizations, status forms), alphabetically or by some other classification system relevant to the system (patient information, costing information, resource information).
b) Rule writer—this tool allows the reviewer or administrator to write rules relating to the variables. Rules can be simple, such as screening for missing values, or quite complex, like comparing summary measures across multiple records. For example, the custodian may wish to check that an appropriate type of dialysis access was created prior to a patient initiating hemodialysis or that the number of hemodialysis catheter insertions only exceeds the number of removals by one (only one catheter should be in place at a given time). Patients often receive multiple catheter insertions and removals over time so the total number of records must been summed and compared to determine if the data is correct.
c) Message writer—this tool allows the reviewer to write the messages that are displayed when a rule is violated. These rules can be either static or dynamic. Static messages may not contain variables that change in value depending on the rule violation and are used for simple errors (e.g. “please complete the date of birth”). Dynamic messages contain values of variables. For example, if there an error with a specific hospitalization, the message can contain the date of the hospitalization so the custodian can find the record faster if the patient has had multiple hospitalizations (e.g. “please complete the reasons for admission using the drop down list for the hospitalization on Jul. 5, 2012”. The date in this case is a dynamic and changes depending on the error.
d) Rule violations database—this database stores all the rule violations that occur when a custodian submits data for automated review. Each violation is linked to a custodian and classified. Analysis of this data can be used to create a user profile. The user profile can be used to send the user targeted education. This education could include written tips, web tutorials, or appointments for one to one training. For example, if a custodian cumulates 3 errors of the same type over are period of time they are sent link to a web training video to coach them through this problem. The custodian profile can also be used to identify high performing users to provide them recognition or awards to encourage high quality data entry. Broader analysis can also inform system design. It may be helpful to clarify the way in which questions are asked or to ask questions in more objective ways (e.g. use of radio buttons rather than text fields). A skilled reader will appreciate that the system may include a profile manager configured to manage and enhance user profiles in order to streamline or automate various processes described herein.

6) Advancement of the data cycle—the logic system of the present invention may be used to review data in “packages” so it is timely and does not overwhelm custodians. In other words, one aspect of the system is the design of “tasks” from a number of respects for improving quality, including by defining and communicating tasks in a way that they are manageable. Clinical research has proven data entered prospectively is much more accurate than retrospective data collection. Baseline data generally includes key demographic and comorbidity information, then outcome data is collected. The time period for each stage is usually 90 days but it can be adjusted depending on the nature of the data collected.

In one possible implementation of the invention, once each package of data is approved by the automated review process, the system may be configured to initiate:

(A) A copy being sent to an analyzer or analysis database. The analyzer may be supported by analytics engine 33 shown in FIG. 1B. This data may then be analyzed to produce accountability and quality assurance reports. Second, the case or task may be returned to a custodian for the next cycle of data completion (in other words the data quality processes may involve, based on the applicable rules, multiple iterations of review for example). The patient records can be sent back to the original custodian or sent to a new custodian based on criteria (e.g. request from original custodian, change in location of the patient) or distributed using other algorithms.

(B) If the patient has experienced a terminating events (recovery of their illness, death etc) their records are identified as complete and data entry stops. The records can be reactivated, should the need arise (e.g. patient transfers back into a dialysis program for example).

In one implementation, the logic system may run automatically without human intervention. The system allows front line health care workers to collect clinical trial quality data on large populations. To ensure this goal is met, records can be randomly reviewed by human auditors. This may involve for example comparing the data approved by the logic system to source documents such as the paper or electronic chart. This is also how clinical trials confirm data quality. In addition, periodic human review allows the development of new logic rules by identifying mistakes or inconsistencies in coding that are not currently captured using the rules engine. The workflow manager 23 may implement a series of audit related processes. These audit related processes may also be triggered by output from the analytics engine 33.

### Description of Possible Workflow

What follows is a possible workflow initiated by execution by the logic system.
1. Registration—Patients may be entered into the logic system during registration.

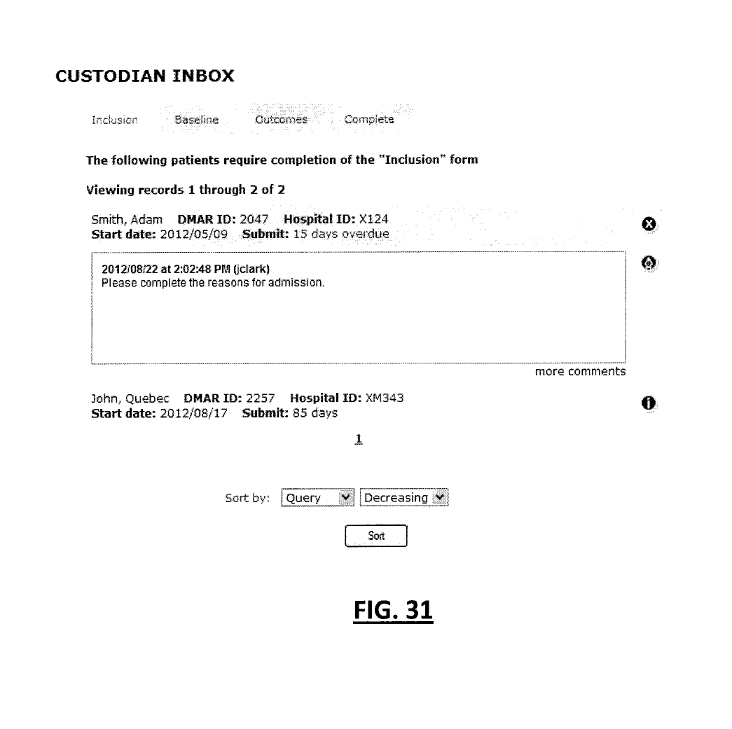

Patients can be manually entered by a health care worker (administrative assistant or nurse) or they can be linked to another source of patient information (e.g. clinic roster, patient registration systems in the hospital). The system of the present invention may assign registered patients to a “custodian” who is the health care custodian who is responsible data entry on the patient. Ideally, the custodian is involved in the care of the patient so they have direct access to their medical information and know the patient well, however, based on the rules other allocations are also possible. Once assigned, only the custodian can enter/edit data on the patient which increases accountability for data quality.
2. Distribution of patients—in order for large amounts of data to be collected, the patients entered into the logic system, the system of the present invention distributes tasks amongst custodians (who may be in different locations) base on a “many hands make light work” approach. The system can assign all patients to one custodian initially who then can forward cases to new custodians (triaging), or the system can automatically assign different custodians based on set registration criteria. For example, patients can be distributed randomly among six custodians that are part of a group that matches to the required tasks ability to meet data quality parameters. Alternatively, custodians can be assigned based on the location where the patient receives care. For instance, patients receiving care in a clinic are assigned to custodians in the clinic and patients receiving care in the hospital ward or assigned to custodians working on that ward. This method ensures the custodians entering data know the patients, which improves the efficiency and quality of data entry.
3. Presentation—the patient records for example are presented to their respective custodians to prioritize data entry. Front line health care workers are busy and have limited periods of time to enter data during their work week. The presentation layer of the logic system allows the custodian to login and immediately view an “in-box” similar to email. This inbox identifies all patients they are responsible for, the stage of data collection (baseline, follow-up), and the amount of time left to complete the data, and displays comments from any prior custodians to assist with data completion. In addition, it highlights cases that are overdue (for example as shown in FIG. 31). If the record was forwarded from another custodian they can also read the last message to guide their data entry. For example, the patient may have been treated in an outpatient clinic but is now admitted to hospital. The outpatient clinic custodian can inform the receiving custodian which data remains to be completed.
4. Data entry—from the in-box the custodian can open each record for data entry, or correction/validation or other associated processes. Opening the records allows the custodian to access the data entry forms. These forms are completed similar to any other databases.
5. Activating automated review—the system of the present invention is designed so custodians can enter data and save it on each form. They are not required to complete all fields on a form before saving a record, which is a common method of forcing complete data in current databases. This allows the custodians to enter data when they have time and save a partially completed form, They also can move back and forth between forms as data becomes available to them (e.g. they receive a discharge summary from a recent hospitalization). However, once the data forms are completed the custodian then can activate the automated review process which runs numerous rules to automatically check the data quality. The custodian then receives automated messages to correct any data errors, including based on the rules defined using the system.

### Possible Implementations

This disclosure describes various possible systems that constitute different applications or implementations of the system 11 described thus far.

Referring now to FIG. 2, the server device 12 includes a controller 40 which includes a number of modules that may perform specified functions on the server device 12. The controller 40 can include one or more microprocessors that are coupled to a storage 42 that includes persistent and/or transient memory. The storage 42 stores information and software enabling the microprocessor(s) of controller 40 to implement the functionality described herein. In one example embodiment, the modules on controller 40 are implemented by software applications running on a processor of the controller 40, the executable code for such applications being stored on the storage 42. As shown, the controller 40 includes a patient information manager module 44 and an administration module 46. The patient information manager module 44 further includes an access module 48, a messaging module 50, a reviewing module 52, a management module 68, and a query module 69. The administration module 46 allows higher level functionality within the system by an administrator (who may for example be the principal investigator 20). In various embodiments, additional or fewer modules may be implemented by controller 40, and some or all of the functions performed by some modules could be combined into other modules or split into separate modules. In some example embodiments, rather than having all the code for the modules present on the server device 12, at least some of the modules shown in FIG. 2 could be at least partially hosted on a device other than the server device 12, such as on a remote terminal 14 (FIG. 1A). Such combinations of functionality between devices may occur and could collectively be considered the “server”. The server device 12 may include a web server, which communicates with the remote terminals 14 over the network 16 using a communication protocol such as HTTP and providing content via such applications as HTML, PHP, ASP, .NET, JAVA, etc. The server device 12 may therefore provide the content for generating user interface(s) on the remote terminals 14, as can be understood by those skilled in the art. As shown in FIG. 2, the storage 42 may also include patient record(s) 66 which include patient information relating to registration 54, inclusion/exclusion 56, baseline 58, and outcomes 60. The storage 42 may also include logic checks 64, which include predetermined rules relating to verification and acceptability of entries in various user interfaces, as is further described below. The server device 12 also includes a communications subsystem 62 for communicating over the network 16. The communication subsystem 62 may include one or more receivers, transmitters, Ethernet connections, and associated components, and a processing module such as a digital signal processor (DSP). As will be, apparent to those skilled in the art, the particular design of the communication subsystem 62 will be dependent upon the communication network(s) in which the server device 12 is intended to operate.

Generally, in some example embodiments, the controller 40 and the modules therein may provide certain features implemented by the server device 12 which may herein be referred to as a “Custodian system”. It is generally not desired to have multiple users modify the same patient record at the same time. For example, there may be lack of accountability if multiple parties are able to modify the same patient record. The Custodian system generally facilitates access and modification rights and communications between the various parties who may access the server device 12, such as the principal investigator 20, nurse 33, and reviewer 30. The Custodian system generally allows users to send each other questions, send out data queries, and clarify instructions and, definitions to each other, and especially with the principal investigator 20. In addition, patient records can be forwarded to other users for review or input, to determine whether the patient record is acceptable, for example to proceed to a next stage of data collection. The term “forwarded” herein refers to the record remaining on the server but modification rights being transferred from one user to another. A “custodian” herein refers to a user who is currently responsible for entering data of a particular patient record. The patient record resides in the custodian's inbox and the current custodian has rights to modify the patient record. In some example embodiments, the right to modify is an exclusive right to modify. For example, the nurse 33 could register a patient and become a current custodian. He/she could then “forward” the record to another nurse 33 who knows the patient well to help complete the baseline patient information. The nurse 33 would now be the custodian of the subject patient and a link to the subject patient record would appear in his/her inbox. Once the subject patient record or entry is complete, it is forwarded to the principal investigator 20 for review. In some embodiments, the Custodian system may allow different levels of security clearance to be assigned to different users. In some example embodiments, further levels of access are provided e.g., a systems administrator, an auditing role.

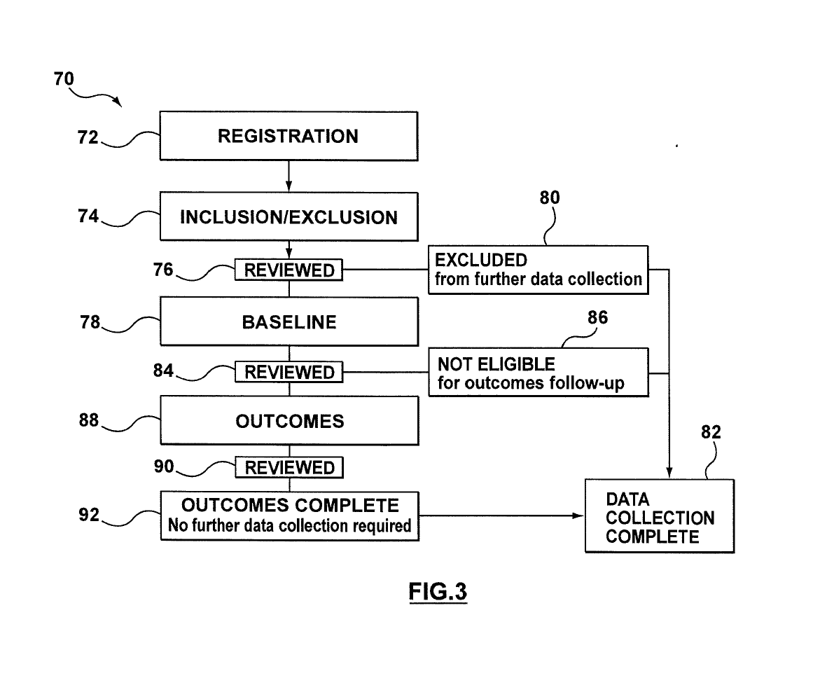

Reference is now made to FIG. 3, which shows a flow diagram 70 of a process implemented by the server device 12. The flow diagram 70 relates generally to a particular patient record containing patient information relating to a subject patient.

As shown, there are a number of stages of data collection including baseline characteristics, eligibility for dialysis treatment modalities, and/or dialysis outcomes. Note that in some example embodiments each stage may in fact represent multiple stages. At step 72, there is registration which creates the subject patient record within the patient database in the server 12 (FIG. 2). At step 74, inclusion/exclusion criteria are entered in relation to the subject patient record. At step 76, the subject patient record is reviewed to determine, based on medical logic rules, whether the patient information is consistent with theother variables in the patient record in order to proceed to a next stage of data collection. The medical logic rules may also include principles specifically based on kidney disease or dialysis treatment. In some example embodiments, the reviewing module 52 residing in the server device 12 performs data or logic checks on the patient record, as further described herein. In some example embodiments, the review step 76 may prevent the particular patient record from proceeding to the next stage of data collection (in this case the baseline step 78), until the patient record is reviewed. if in the review step 76 it is determined that the particular patient record should be excluded from further data collection, the flow diagram 70 proceeds to the excluded step 80. Following this, the flow diagram 70 proceeds to step 82, which completes the data collection process for the subject patient record. Referring still to review step 76, if the subject patient satisfies the inclusion criteria upon review, the flow diagram 70 proceeds to step 78, wherein baseline information may be entered into the server device 12. At step 84, the patient record may once again be reviewed. If, upon the review step 84, the patient record is to be excluded based on the baseline information, the flow diagram 70 proceeds to step 86, and once again the patient is excluded from further data collection and data collection is completed (step 82). If the patient record satisfies the inclusion criteria, the flow diagram 70 proceeds to step 88, wherein outcome information is recorded. This outcome information may be further reviewed, referring to step 90, and indicated as complete at step 92. At this stage, the data collection is completed (step 82). In some example embodiments, referring to FIG. 2, the server device 12 may automatically proceed to a next step in the flow diagram 70 based on the logic checks 64.

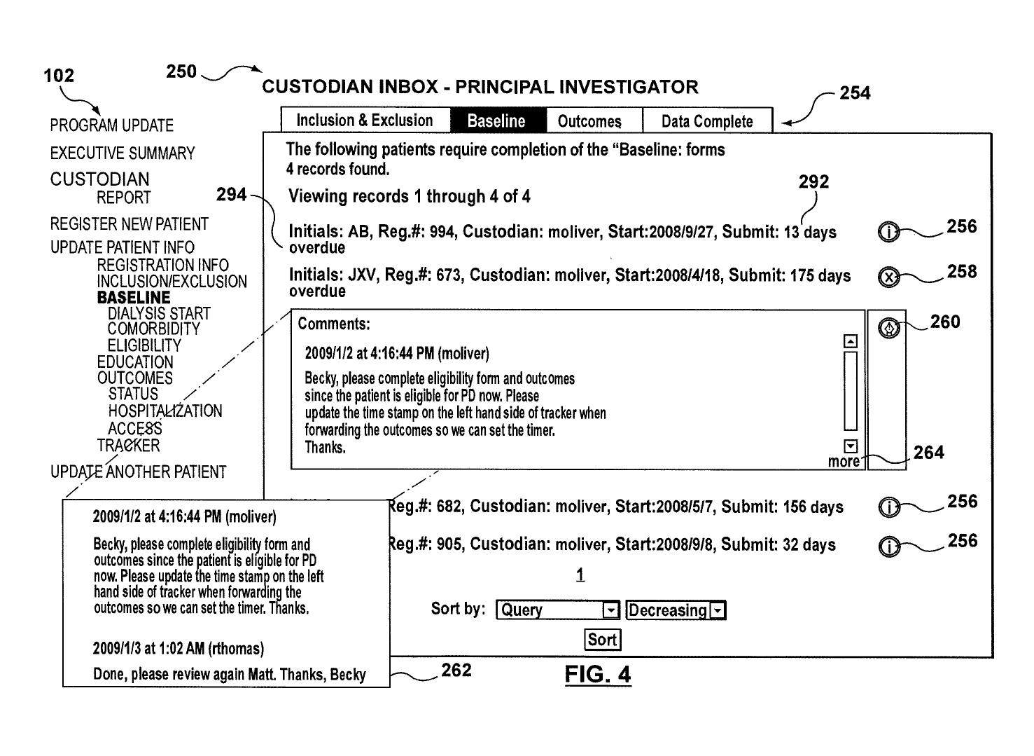

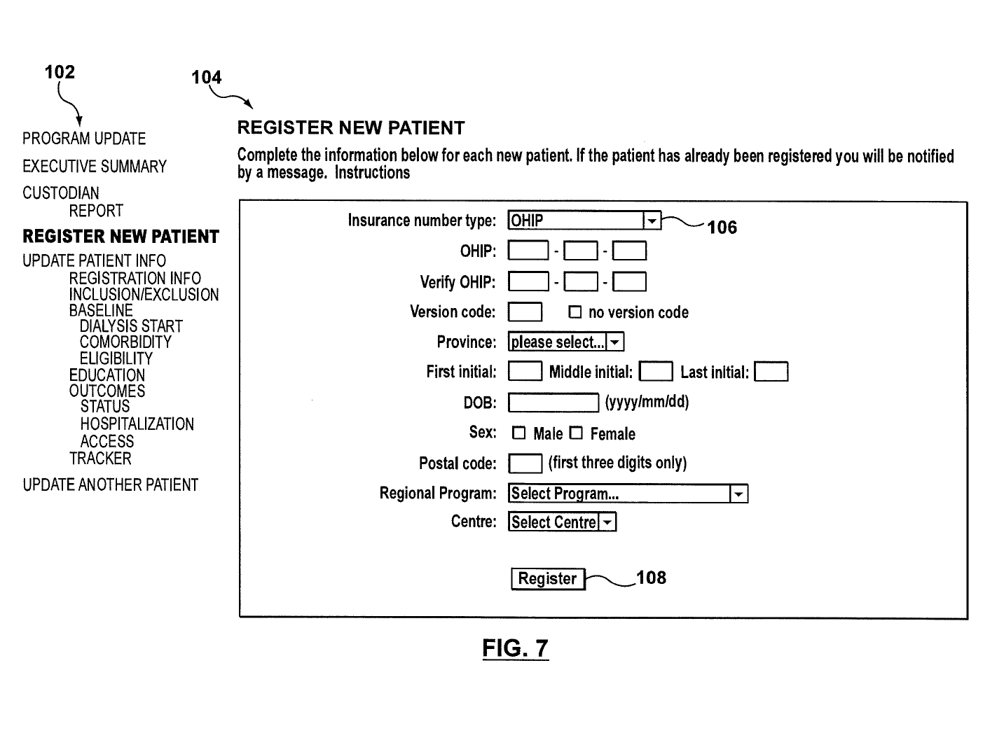

Referring to FIG. 1A, an example operation by a nurse 33 will now be described, referring to FIGS. 7 to 10, which show example graphical user interface screens as displayed on a remote terminal 14, for example accessed and used via the remote terminal 14. The interaction with the principal investigator 20 will also be described, with reference to FIGS. 4 to 6, which shows example graphical user interface screens as displayed on another remote terminal 14 for use by the principal investigator 20.

Referring briefly to FIG. 4, an end user 32 may log into the server device through a login page (not shown) using an assigned login name and password. Successful login results in a user interface screen being shown, which includes an options menu 102. The options menu 102 includes a number of user-selectable options, as shown, including program update, executive summary, custodian, register new patient, and utilities. The options menu 102 is shown as a left task bar, wherein the currently selection option is highlighted, for example by being bolded as shown. The right side of the user interface screen generally displays the particular user interface resulting from the menu option being selected. Additional user interface screens may also be shown on the right side based on user selection and navigation through various subsequent user interfaces. Selection of “Program Update” from the options menu 102 results in a user interface (not shown) showing date-stamped updates relating to the system.

Selection of “Executive Summary” from the options menu 102 results in a user interface (not shown) showing a summary of the system.

FIG. 4 illustrates a possible implementation of the presentation layer of the data quality platform of the present invention. FIG. 4 shows a possible view generated by the presentation layer for a custodian, in this case a principal investigator. The tabs at the top are the data stages. The comments box are the messages we refer to when a custodian passes a record to another custodian.

A skilled reader will understand that FIGS. 4 to 22 illustrates representative implementations of the present invention, and particularly possible screens presented by the presentation layer, based on examples of medical data forms that may be designed using the platform, and may be completed by the crowd of custodians managed using the platform.

Referring now to FIG. 7, an end user 32 such as nurse 33 may select “register new patient” in the options menu 102 which results in the graphical user interface displaying a registration page 104. As shown, the subject patient records are input and thereafter identified using the patient's initials, registry number, and date of birth (DOB). It is thus appreciated that the subject patient's information may be anonymized to protect patient privacy in the system while maintaining sufficient detail to assist the user to confirm that they are working on the correct patient's record. Thus, in some example embodiments identifiers such as full name of the subject patient are not present so users viewing particular patient records from outside the centre cannot identify the patient, and for example to comply with privacy regulations. All the personal identifiers and comments (where identifiers could be typed by mistake) are encrypted prior to storing in the storage 42 (FIG. 2) (the system still stores a permanent record of all entries). The type of provincial insurance, for example OHIP (Ontario Health Insurance Plan), may be selected from insurance drop down bar 106. The provincial insurance number is transformed by the server during registration and encrypted to create an encrypted provincial health insurance number (EPHIN). The EPHIN is created by a one-to-one encryption algorithm, as would be understood by those skilled in the art, which may be used to retrieve the original provincial insurance number using the EPHIN. Thus, the EPHIN allows users to request the patient's original health insurance number, with appropriate safeguards in place, if they lose a patient's registry number or cannot identify a patient in the system. This may reduce the chance that an anonymized record will become orphaned in the system. Once the registration page 104 is completed, the user may select the “register” icon 108, which causes the remote terminal 14 to send the patient information to the server device 12, and creates a new patient record 66 relating to the subject patient information as input into the registration page 104. In some example embodiments, mandatory fields in the various interfaces are indicated by shading or an asterisk (*), and an error message may be displayed indicating which mandatory fields are missing.

Generally, once the subject patient information is registered using the registration page 104, the user entering the information (the nurse 33 in the present example) becomes the current custodian.

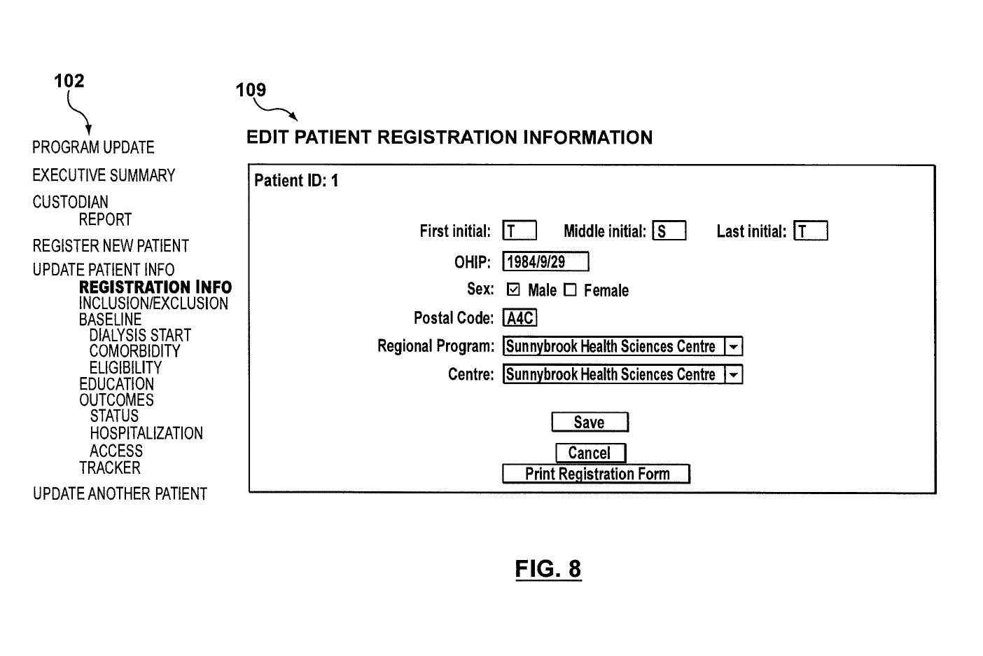

Referring now to FIG. 8, the user may now edit the patient registration information by selecting “registration info” from the options menu 102, which results in the edit patient registration information page 109 being shown. The user may edit the information to correct any errors. Any changes can be saved by selecting the “save” button.

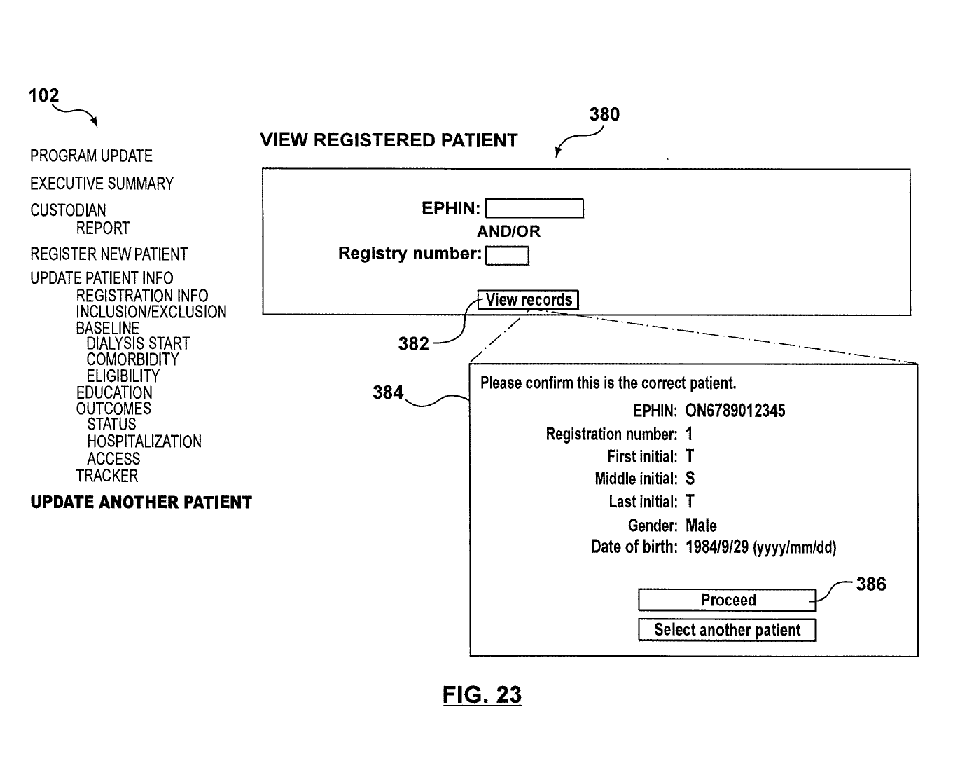

The user may now or enter some of the remaining patient information by selecting “update patient info” from the options menu 102. Referring now to FIG. 23, should the user wish to update the information for another patient record, the user may select “Update another patient” from the options menu 102, which results in the view registered patient page 380 to appear. The user inputs the EPHIN or Registry number, and selects “View Records” 382, which results in a confirmation page 384 (or popup) that asks for confirmation of the patient's identity. Click on “Proceed” 386 and the particular patient record is now the current patient record accessible for editing via selection of any of the options under “Update Patient Info” in the options menu 102.

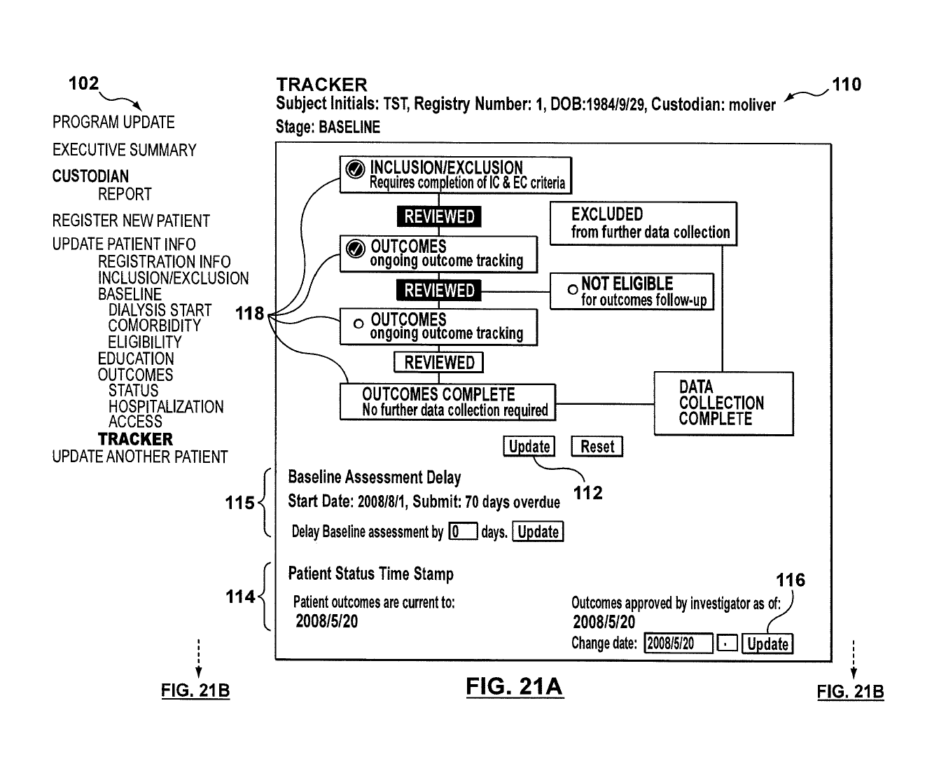

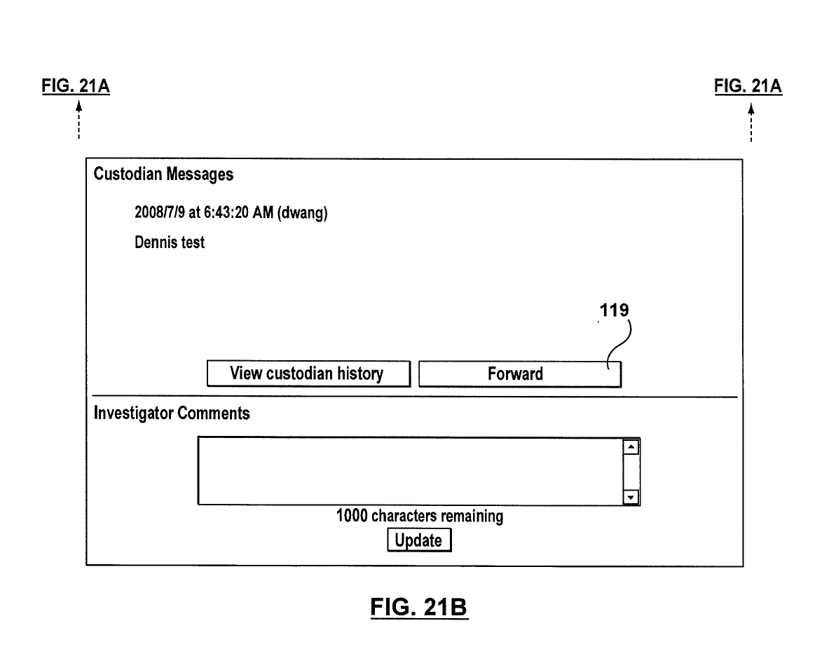

Referring now to FIGS. 21A and 21B, the present custodian (the nurse 33 in this example) views the status of a registered patient by selecting the “tracker” from the options menu 102, which results in the tracker page 110 being displayed on the user interface. In the example shown, the tracker page 110 displays the particular stage of data collection for the subject patient record, for example “inclusion/exclusion”, “baseline”, or “outcomes”, as shown. A user (typically the reviewer 30) may toggle the acceptance or non-acceptance of the present stage by selecting the particular icons 118, and advance the present stage of data collection by selecting the update button 112. In some example embodiments, access and modifications rights are limited to the principal investigator 20 and/or the reviewer 30, and the nurse 33 may merely have viewing rights to the tracker page 110. Selection of the update button 112 provides an instruction to the server device 12 that the present stage of data collection has been reviewed and is accepted or not accepted. Prior to review and acceptance, further modifications may be made to the patient record, as described in further detail below. If the particular patient record is accepted, the patient record in the tracker page 110 may advance to the next stage of data collection. In the example shown, the patient record has been reviewed and is presently in the “outcomes” phase. When a patient record is in the outcomes phase, a further outcomes menu 114 is displayed which allows a user to input the date of the most recently approved outcomes, and submit same by selecting the update button 116.

Reference is now made to FIG. 4, which illustrates in detail the Custodian system, as shown on graphical user interface screens as displayed on another remote terminal 14 for use by the principal investigator 20. Referring to FIG. 4, the principal investigator 20 may select “Custodian” from the options menu 102, which results in the user interface displaying the “Custodian Inbox” page 250. The “Custodian Report” page 250 includes Custodian menu options 254 for “inclusion/exclusion”, “baseline”, “outcomes”, and “data complete”, the selection of which displays those particular patient records within the window. In this example, the “baseline” has been selected in the Custodian menu options 254, which displays the particular patient records pending review or modification which are in the “baseline” stage of data collection, as shown in the inbox 250. As shown, next to each patient record is the “details” icon 256. By selecting the “details” icon 256, the page displays the comments or questions pertaining to that particular patient record. As shown, all entries may include a time and date stamp. The edit icon 260 represented by a fountain pen also appears. If a user wishes to read all of the text comments entered on the patient, select the “more” link 264 in the bottom right hand corner of the comments box. A pop-up window 262 will then appear containing the requested information. To minimize the patient record, select the “X” icon 258, which closes the comments box and the edit icon 260 will also no longer be displayed.

In order to open a patient record for review or to edit/modify the record, select the edit icon 260. Another page may appear that asks for confirmation of the patient's identity (similar to the page shown in FIG. 23). The user selects “Proceed” and the particular patient record is now the current patient record accessible for editing via selection of any of the options under “Update Patient Info” in the options menu 102.

Generally, referring still to FIGS. 21A and 21B, the inclusion and exclusion criteria may assist in defining a uniform population of dialysis patients for all participating facilities. Similarly, baseline characteristics (which include characteristics measured at the start of dialysis) and patient outcomes (which include rates of hospitalization, interventional procedures, technique survival, and death) will be tracked in a subject patient's individual dialysis program over time and can be compared to other facilities. Having uniform inclusion and exclusion criteria ensures that the same type of patient information is compared when performing further data analysis on a collective scale. Whenever possible, it can be appreciated that objective information may be collected to reduce subjectivity and possibility of error.

In some example embodiments, the server device 12 includes a timer module which determines a predetermined time period, in this example 90 days, from the date the update button 116 is selected, and reminds the current custodian to update the patient record when 90 days have elapsed since the last update. This period may be manually extended or delayed by inputting the number of days to delay the baseline assessment using the baseline assessment delay menu interface 115, and selecting “update”. Referring briefly to FIG. 4, any records marked as “overdue” in the custodian inbox are based on this overdue date.

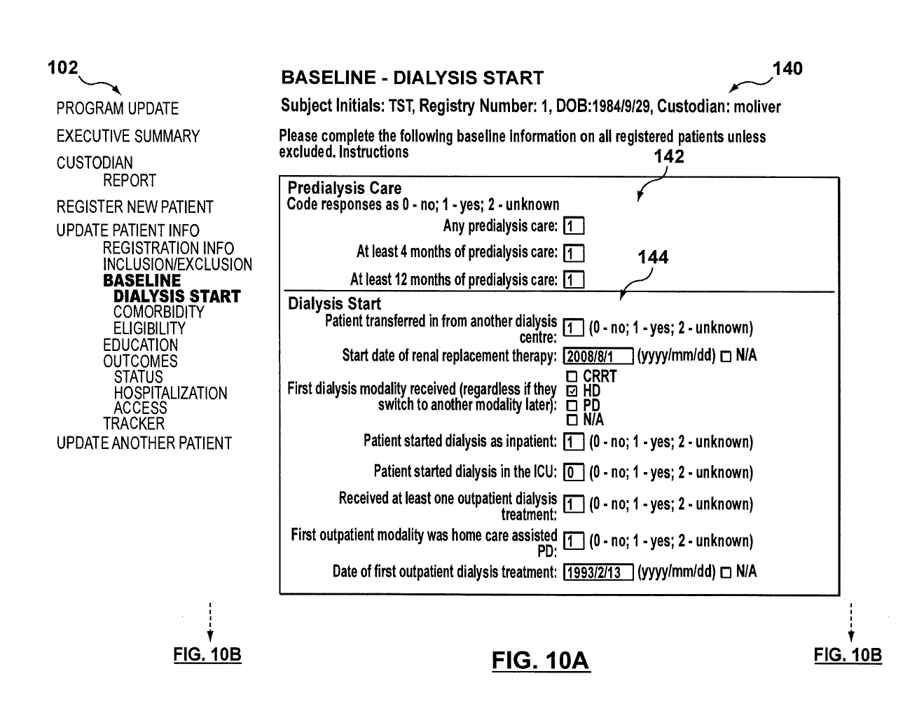

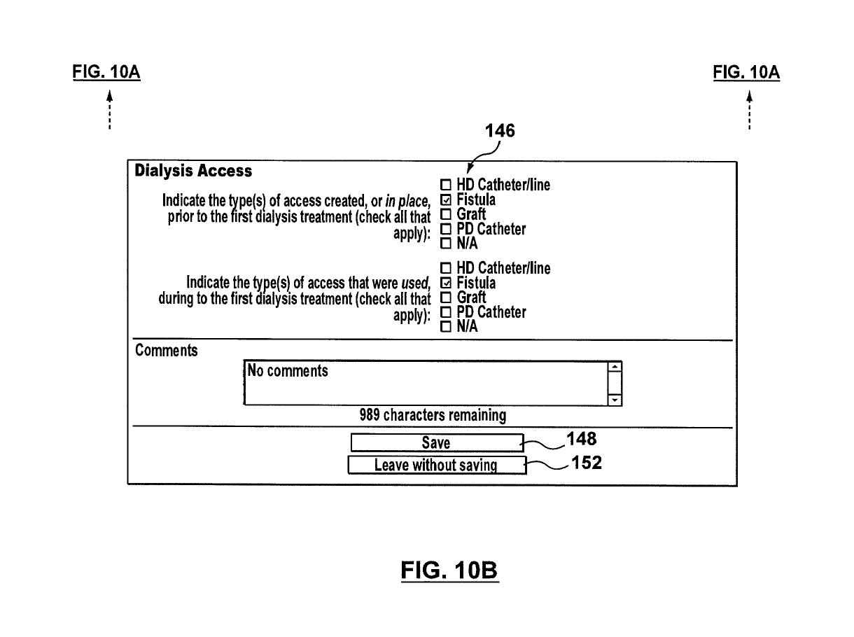

The current user (who is the custodian) may make further changes by navigating through the appropriate submenu items under “update patient info” in the options menu 102. If the user has a question or comment regarding a particular variable, the user may further use a “query system”, which is described in detail below with respect to FIGS. 10A to 14. The current user may forward to another custodian by selecting the forward button 119.

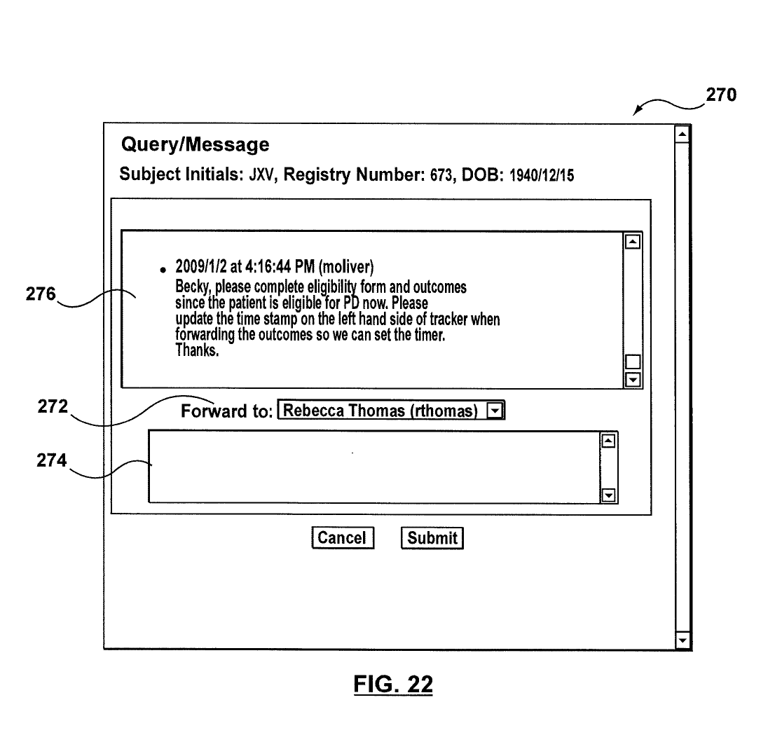

Referring now to FIG. 22, selection of the “forward” button 119 results in the message box 270 being displayed. The message box 270 may be displayed as a new user interface, nested within an existing user interface, or may “popup” on the display. The message history is also shown in history box 276. The user may select on the drop-down menu 272 labeled “Forward to:” to select the individual that to send the patient record to, for that individual to be come the present custodian. There is also a text box 274 below that which may be used to send a message associated with the patient record. The user may indicate the reason why the record was sent to the new custodian in the text box 274 so that he/she is clear on what needs to be done or what question needs to be answered. The new custodian will be able to read the comments which were input in the text box 274 when the patient record appears in their custodian inbox (described below with respect to FIG. 4). The new custodian will now have sole and/or exclusive modification rights. Referring briefly to FIG. 4, the patient record will be removed from the former custodian's inbox 266, but will appear on the new custodian's active patients list. The former custodian will no longer be custodian and no longer have modification rights to the record.

A skilled reader will understand that FIG. 22 presents an example of an implementation of the messaging utility or window of the present invention.

There are some example situations in which a user might wish to forward a record to someone else: if the user has a data entry question to ask the principal investigators 20, use the custodian system to forward the question to them; if the user would like to ask someone else more knowledgeable about a patient to enter specific data elements, the user can forward a patient record to them for completion; and/or if a nurse 33 has completed all the required information for a given patient, the nurse 33 may be asked to forward the record to the principal investigator 20 and/or the reviewer 30.

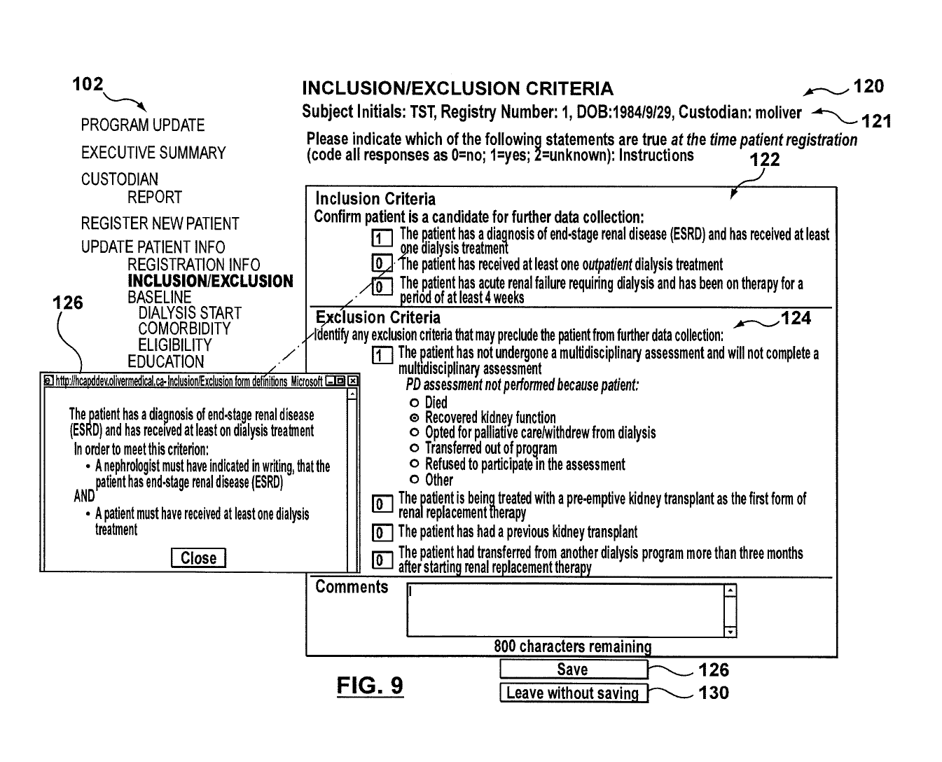

Referring now to FIG. 9, a user may select “inclusion/exclusion” from the options menu 102, which results in the user interface displaying the inclusion/exclusion criteria page 120. As shown a header 121 identifies the initials, registry number, date of birth (DOB), and present custodian of the subject patient record, which are displayed so that the user can confirm that the subject patient is the correct patient being reviewed. The inclusion/exclusion criteria page 120 includes an interface for inclusion criteria 122 and an interface for exclusion criteria 124. As shown, the user inclusion/exclusion criteria page 120 includes limiting the user interface to specific entries or symbols representing a descriptive response, such as the use of Numerical Coding (0, 1, 2). The nurse 33 inputs code “0” if he/she is certain that the answer is “no”, code “1” if certain that the answer is “yes”, and code “2” if the answer is “unknown”. Unknown indicates that the nurse 33 has reviewed the patient's information and the answer is still not clear. Numerical coding may for example be useful for conditions or variables where it is important to distinguish between “no” and “unknown”. In some cases, an unknown value might be later determined and input with a more extensive review of medical records. Once the page 120 is completed, the nurse 33 may select the “save” button 126 which saves all of the patient information from the page 120, for example by storing the patient information into the patient record 66 stored under inclusion/exclusion 56 in the server device 12 (FIG. 2). The nurse 33 may also select the “leave without saving” button 130 which will navigate away from the present inclusion/exclusion criteria page 120 without saving the patient information. The nurse 33 can now “forward” the patient record by using the tracker page 110 (FIGS. 21A and 21B).

For each of the user interfaces in the system, a user can select a particular variable, which provides a hyperlink or popup which explains that particular variable. For example, as shown in FIG. 9, selection of “The patient has a diagnosis of end-stage renal disease (ESRD) . . . ” results in a popup 126 which provides a definition for that particular variable. This provides a convenient help function for the user.

Referring still to FIG. 9, the inclusion/exclusion criteria page 120 will be described in greater detail. Generally, the inclusion criteria may include objectively defined events and information which may provide transparency and consistency in the patient information being obtained. For example, it is often difficult to know when a patient with acute renal failure becomes a “chronic dialysis patient”. For this reason, patients who start dialysis acutely will be included in the system 10 once the subject patient has received treatment for an objective and standardized time period, 4 weeks in this example. By doing so, it may be possible to apply a consistent definition to each patient, and across different regional dialysis programs in different facilities. As shown in the interface for inclusion criteria 122, the nurse 33 may input (0, 1, 2) into the input fields. With respect to the field “Written or verbal diagnosis of ‘Stage 5 Chronic Kidney Disease’ or ‘End-Stage Renal Disease’ by a nephrologist in a patient who required dialysis therapy or a pre-emptive transplant”, in order to meet this criterion, a patient must have received at least one dialysis treatment or a renal transplant, and a nephrologist must have indicated verbally, or in writing, that the patient has end-stage renal disease (ESRD). With respect to the field “Received at least one outpatient dialysis treatment”, this means that a patient started hemodialysis or peritoneal dialysis as an outpatient (not while admitted to an acute care hospital); or Started dialysis in hospital, was discharged, and received treatment in an outpatient hemodialysis unit, his/her residence, or a rehabilitation facility; or Started dialysis in hospital, was discharged, and received peritoneal dialysis in his/her residence, a nursing or retirement home, or a rehabilitation facility. With respect to the field “Written or verbal diagnosis of “Acute Renal Failure” or “Acute on Chronic Renal Failure” by a nephrologist and has received at least 4 consecutive weeks of dialysis treatment”, this field is input if the subject patient who may have acute renal failure or acute-on-chronic renal failure; and has required dialysis for at least 4 consecutive weeks. In the interface for exclusion criteria 124, with respect to the field “Patient not able to be fully assessed by multidisciplinary team because he/she was lost to follow-up, moved to another dialysis program, refused to participate in the assessment, withdrew from dialysis, or died”, if a subject patient was lost to follow-up, moved, withdrew from dialysis, or died before the multidisciplinary team could adequately assess them, this is coded as “1”. If the subject patient refuses to participate in the assessment, then this is also coded “1”. With respect to the field “Age less than 18 years at the start of dialysis”, if a patient is under 18 years of age the first time that they receive dialysis therapy, they are excluded from the analysis. With respect to the field “Previous Kidney Transplant”, this means that a patient has had a previous kidney transplant (any type). With respect to the field “Initially felt to have ESRD, but recovered kidney function”, this means that a patient is initially felt to have end-stage renal disease in the opinion of the nephrologist or mutlidisciplinary team, but later recovers enough kidney function that he/she no longer needs dialysis therapy. With respect to the field “Transferred from another dialysis program more than 3 months after starting dialysis”, a subject patients who started dialysis at another facility and then transfers to the present facility or treatment program more than 3 months after the first treatment are excluded form the analysis. A “1” is entered if a patient meets this criterion. With respect to the field “Started on chronic dialysis for an indication other than Stage 5 kidney disease”, this refers to a patient that was started on dialysis for an indication other than Stage 5 kidney disease. For example, a patient with Stage 4 chronic kidney disease and congestive heart failure who is started on dialysis for ultrafiltration (fluid removal) would fall under this category. With respect to the field “Patient received a pre-emptive transplant as the first form of renal replacement therapy”, this refers to a patient who has Stage 5 kidney disease that was treated with a pre-emptive transplant and did not require dialysis prior to receiving it. In some example embodiments, such inclusion/exclusion patient information may be considered objectively defined patient information, since the nurse may not be performing any subjective diagnosis but rather determining whether such diagnosis has been made previously by a nephrologist. The nurse may be merely obtaining such information from a patient chart or patient interviews, etc.

Referring to FIG. 2, the logic checks 64 of the server device 12 include predetermined rules relating to the acceptability of the user entries relating to the inclusion/exclusion criteria page 120. The logic checks 64 may thus provide at least an initial indication of whether a patient is to be included or excluded based on the logic checks 64. For example, if any one of the fields in the interface for exclusion criteria 124 are marked as “1” (yes), this may result in the subject patient record being flagged in memory of the server device 12 as being excluded. If any one of the fields in the interface for inclusion criteria 122 are marked as “1” (yes), and no exclusion criteria 124 are flagged as “0” (no), this may result in the subject patient record being flagged in memory of the server device 12 as being eligible for dialysis treatment. The principal investigator 20 may thereafter be given access and modification rights to the patient record via the Custodian system, to perform further reviewing and verification of the patient record, before indicating the patient record as being excluded or included (e.g., using the tracker page 110 (FIGS. 21A and 21B). In other example embodiments, the patient record is automatically excluded or included based on the logic checks of the server device 12 without further review.

Referring now to FIGS. 10A and 10B, if the subject patient record is indicated as being excluded, the user interface may not permit the nurse 33 from selecting the next stage of data collection, being “baseline-dialysis start”, from the options menu 102. In some example embodiments, this is accomplished by graying out or removing the particular option on the options menu 102). In other example embodiments, the baseline page 140 is displayed but may not receive any user input in any of the fields. On the other hand, if the subject patient record is flagged or indicated as satisfying the inclusion criteria, the nurse 33 may select “baseline-dialysis start” from the options menu 102, which results in the user interface displaying the baseline page 140, for receiving user input from the nurse 33. As shown, the baseline page 140 includes an interface for Predialysis Care 142, Dialysis Start 144, and Dialysis Access 146. The baseline page 140 also includes a saving button 148 and a leave without saving button 152, which operate as described above. Generally, baseline information relates to what type of dialysis-related access patients have in place. For example, baseline information may be a barometer of how successful treatment may be at getting “fistulas” created prior to the start of dialysis and whether or not the fistulas are maturing in time to be used successfully for the first treatment (e.g. sparing patients of the risk associated with central venous catheters).

Referring to the interface for Predialysis Care 142, as indicated, regarding the field “Any predialysis care” (0—no; 1—yes; 2—unknown), predialysis care refers to outpatient care provided by a nephrologist prior to starting renal replacement therapy. Predialysis care may be delivered by a single physician or by a multidisciplinary team. Referring to the field “At least 4 months of predialysis care” (0—no; 1—yes; 2—unknown), this is defined as at least one visit that qualifies as predialysis care that occurred 4 months or more prior to the start of renal replacement therapy. Referring to the field “At least 12 months of predialysis care” (0—no; 1—yes; 2—unknown), this is defined as at least one visit that qualifies as predialysis care that occurred 12 months or more prior to the start of renal replacement therapy

Referring to the interface for Dialysis Start 144, the field “Patient transferred in from another dialysis centre” (0—no; 1—yes; 2—unknown) indicates whether a subject patient has transferred from another facility. The field “Start Date of Renal Replacement Therapy (yyyy/mm/dd)” is the date that a subject patient received his/her first dialysis treatment. For patients who start peritoneal dialysis as an inpatient, the start date is the date of the first dialysis exchange conducted with the intent of treating the patient. For patients who start electively as outpatients, the start date of dialysis is the last day of training. In situations where patients receive training, but do not start peritoneal dialysis immediately afterwards, the start date of renal replacement therapy is the first exchange with the intent of beginning treatment with PD. Routine catheter flushes and exchanges done during the training period are not considered exchanges with the intent of treating a patient. The field “First dialysis modality received” (CRRT (Continuous Renal Replacement Therapy); HD (Hemodialysis); PD (Peritoneal Dialysis); N/A (Not Applicable)) indicates the first dialysis modality regardless if the treatment modality was later switched. Regarding the field “Patient started dialysis as an inpatient” (0—no; 1—yes; 2—unknown), a subject patient is considered to have “started dialysis as an inpatient” if he/she received the first dialysis treatment while admitted to an acute care hospital. The field “Received at least one outpatient dialysis treatment” (0—no; 1—yes; 2—unknown) refers to whether a patient received one or more dialysis treatments as an outpatient during follow-up. For patients that started dialysis electively as an outpatient, enter “1”. In the situation where an individual receives the first dialysis treatment in hospital, enter a “1” if he/she was discharged home on dialysis. For hemodialysis patients, this refers to a single hemodialysis treatment after discharge. For peritoneal dialysis patients, this refers to the situation where an individual patient is treated with peritoneal dialysis after leaving the hospital and going home (or to a rehabilitation facility or nursing home).

Referring to the interface for Dialysis Access 146, for the field “Indicate the type(s) of access created, or in place, prior to the first dialysis treatment (check all that apply)” (HD Catheter/line; Fistula; Graft; PD Catheter; N/A), the user is to check the box beside any form of access that had been created and was still in place prior to the first dialysis treatment. Check fistula or graft if either was created prior to the patient starting dialysis, regardless of whether it is mature, patent, or used for the first dialysis treatment. In the situation where a patient has more than one access in place when they start dialysis, place a check in all of the relevant boxes. For example, if a peritoneal dialysis catheter was in place and the patient started dialysis through a central venous catheter, a check would be placed beside PD catheter and HD Catheter/Line. For the field “Indicate the type(s) of access that were used during the first dialysis treatment (check all that apply)” (HD Catheter/line; Fistula; Graft; PD Catheter; N/A), the user is to check the box beside any form of access that was used for the first dialysis treatment. In most cases, only a single access will be recorded. In the situation where more than one access was successfully used for the first treatment, a check should be placed in the boxes beside both forms of access and a note entered in the comments box outlining the details. For example, if a patient receives HD as the initial form of dialysis and a single line is run from the central venous catheter and the other line is run from an arteriovenous fistula (AVF), both would be recorded and a note to that effect would be entered into the comments box. If this was attempted and the line in the AVF “blew” or was not successfully used for the entire treatment, only the CVC would be recorded. The access must have been used successfully for the entire treatment to be recorded. The user selects the saving button 148 once completed, and may forward for further review using the tracker page (FIGS. 21A and 21B).

Referring now to FIG. 2, the logic checks 64 of the server device 12 include predetermined rules relating to the acceptability of the user entries relating to the baseline page 140, for example as entered by the nurse 33. These checks may be triggered by the user selecting the saving button 148 or after forwarding using the custodian system. Some example logic checks relating to the baseline page 140 (FIG. 10) are as follows, without intending to be limiting:
1. All fields must be completed with a 0, 1, or 2 in Predialysis Care and Dialysis Start sections. This includes one of the options for first dialysis modality being checked.
2. At least one dialysis access in place must be checked or the N/A box should be checked.
3. At least one dialysis access used must be checked or the N/A box should be checked.
4. If N/A box is checked for dialysis access in place, then none of the other options should be checked.
5. If N/A box is checked for dialysis access used, then none of the other options should be checked.
6. If “at least 12 months of predialysis care is=1, then both “at least 4 months of predialysis care” and “any predialysis care” must be=1.
7. If “at least 4 months of predialysis care” is=1, then “any predialysis care” must=1.
8. If “any predialysis care”=0, then HD catheter/line must be checked for both “dialysis access in place” and “dialysis access used”.
9. If “start date of renal replacement therapy” is missing, then N/A must be checked.
10. If started dialysis as an inpatient=0 then start date of outpatient dialysis must equal start date of renal replacement therapy
11. If started dialysis as an inpatient=1, then start date of outpatient dialysis must be equal to or greater than start date of renal replacement therapy (has been 1 case where hospitalized to start and discharged the same day)
12. If “first modality received” is CRRT, then HD catheter/line must be checked for “dialysis access in place” and “dialysis access used”. In addition, no other options should be checked for “dialysis access used”, although other options could be checked for “dialysis access in place”.
13. If “first modality received” is CRRT, then “patient started dialysis as an inpatient” must be 1 and “patient started dialysis in ICU” must be 1.
14. If “first modality received” is HD, then at least one of the following must be checked for “indicate type of access created, or in place, prior to first dialysis treatment”:
HD Catheter/line
Fistula
Graft
N/A
15. If “first modality received” is HD, then PD catheter must not be checked for “indicate the type of access that were used during the first dialysis treatment”
16. If “first modality received” is HD, then at least one of the following must be checked for “indicate type of access used for first dialysis treatment”:
HD Catheter/line
Fistula
Graft
N/A
17. If “first modality received” is PD, then PD catheter must be checked for “indicate type of access . . . in place . . . first dialysis treatment” and for “indicate type of access used for first dialysis treatment”. No other options can be checked for “indicate type of access . . . in place . . . first dialysis treatment”.
18. Should flag record for review if any of the following variables are missing or coded as N/A:
Start date of renal replacement therapy
Date of first outpatient dialysis treatment
19. If patient started dialysis as an inpatient is 0 then received at least one outpatient treatment must be=1

The logic checks 64 may thus provide an initial automated indication of whether a patient record is to be automatically included or excluded from proceed to the next stage of data collection. As can be appreciated, some of these logic checks are based on medical logic rules. As can be appreciated from the above example logic checks 64, such medical logic rules include completeness, wherein missing values which are medically relevant are flagged, for example to determine whether the patient record is to proceed to the next stage of data collection; validity, wherein data is out of range; timing of events, wherein medical events in patients with kidney disease follow a valid temporal sequence; content and consistency of data, wherein values of variables within the system does not conflict with one or more other values of variables; unknown values, wherein the system identifies data which is coded as unknown and provides targeted education back the user to help resolve the unknown value for variables that require judgement or interpretation to reduce subjectivity. The logic checks may also include whether the patient information is consistent with a previous stage of data collection, in this example from the inclusion/exclusion 56 patient record 66 (FIG. 2). In some example embodiments, the user interface in the remote terminal 14 cannot proceed to the next stage in data collection until these criteria are satisfied.

Referring to FIG. 3, as can be appreciated, similar logic checks may be accessed and used at each of the review steps 76, 84, 90, for each stage of data collection. The subject patient record may not proceed to the next stage of data collection until the logic checks are satisfied.

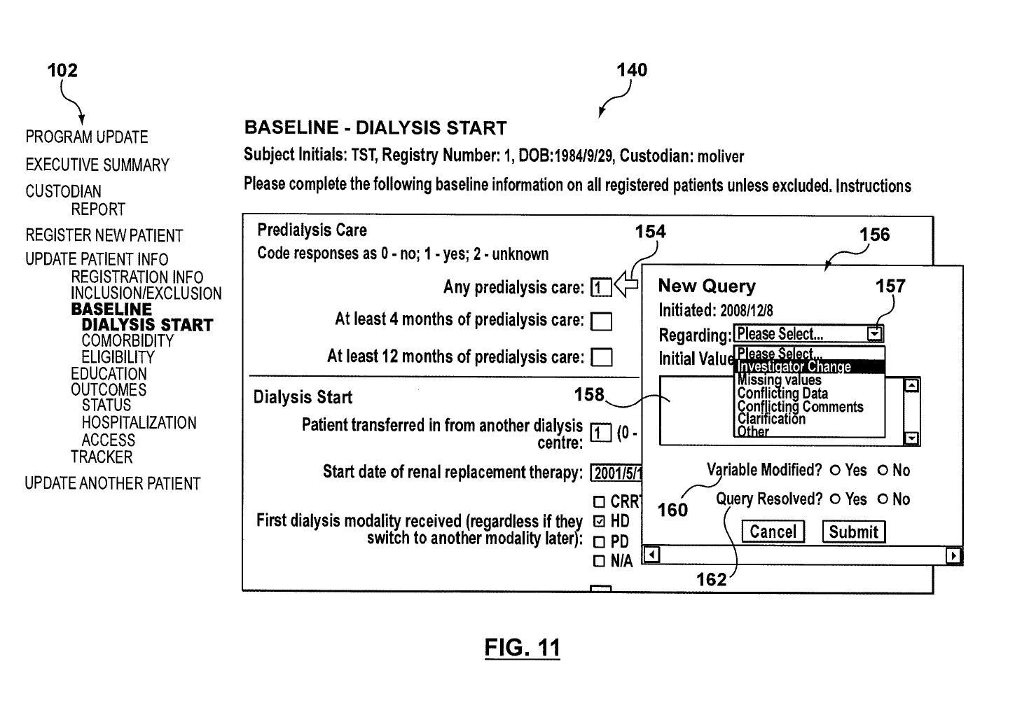

A query system will now be described, having reference to FIGS. 11 to 14. Generally, the query system permits a user (such as a principal investigator) to create a query for a particular variable. The query can relate to a comment on a change made by the principal investigator, missing values, conflicting data, conflicting comments, clarification, or other.

An example conversation between a principal investigator and a nurse using the query system will be described, having reference to FIGS. 11 to 14. As shown in FIG. 11, the principal investigator may initiate the query from the baseline page 140 for dialysis start information. By hovering or selecting near to the right of the first variable (in this example the subject variable is “Any predialysis care”), a green arrow 154 will appear (as shown). When selecting the green arrow 154, the query popup window 156 appears which permits the user to create a query with respect to that particular variable. The principal investigator selects from the drop down menu 157 one of the choices with respect to the query, in the example the choices as shown are a change made by the principal investigator, missing values, conflicting data, conflicting comments, clarification, or other. The principal investigator may also make a message or note in the text box 158 that a change has occurred with respect to that particular variable. The principal investigator selects the radio options under “variable modified” 160, and selects YES for variable modified if the variable is modified. The principal investigator also selects the radio options under “Query Resolved” 162, and selects YES for query resolved if no further modifications are required with respect to the particular variable. Note the default values for these variables is NO. The principal investigator may select “submit”, which submits the query to the next custodian, in this example a nurse. Access rights may be forwarded to the nurse using the tracker page 110 (FIGS. 21A and 21B), as described above.

A skilled reader will understand that the options presented by presentation layer, for example as shown in FIG. 11, may be generated by the rules engine.

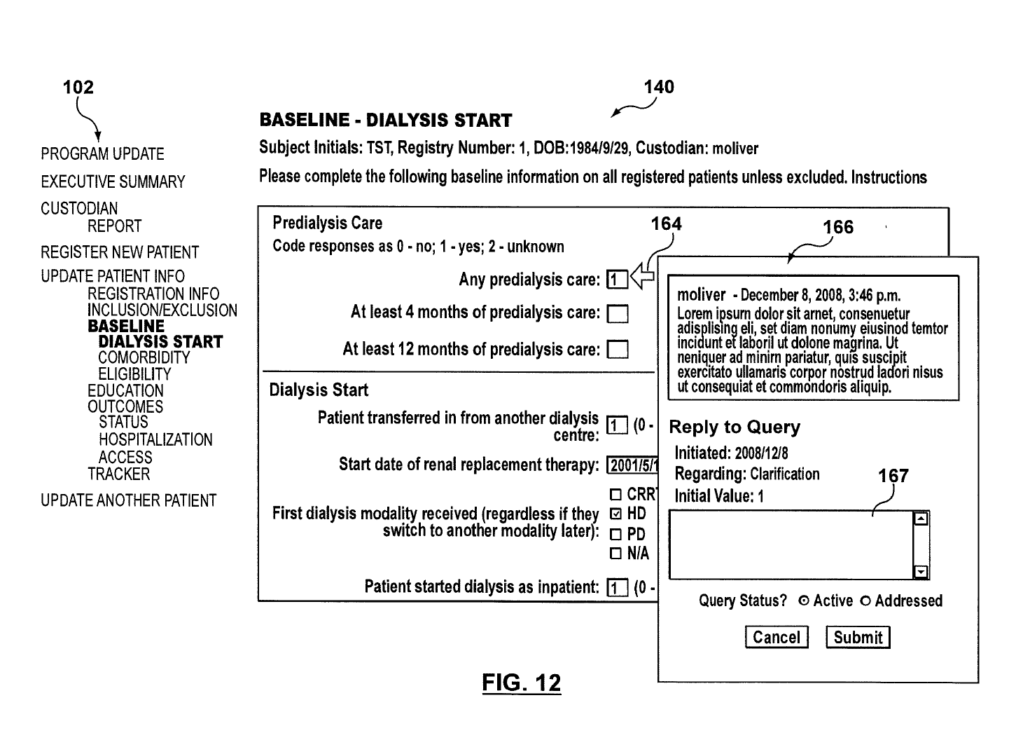

Referring now to FIG. 12, which shows the same page when the present user is a nurse, the nurse is informed of a query being received by an asterisk (*) 163 or other indicator shown in the options menu 102. When viewing the same baseline page 140 the nurse is informed that a query has been received by a red arrow 164 appearing next to the particular variable. By selecting the red arrow 164, another query box 166 is displayed on the screen. As shown, the nurse now can view the text comment from the principal investigator. The nurse does not have a drop down option. The nurse may only respond to the principal investigator using the text box 167. The nurse selects “Submit” when done.

In FIG. 12, window 167 provides an example of an implementation of the messaging utility or window referenced above.

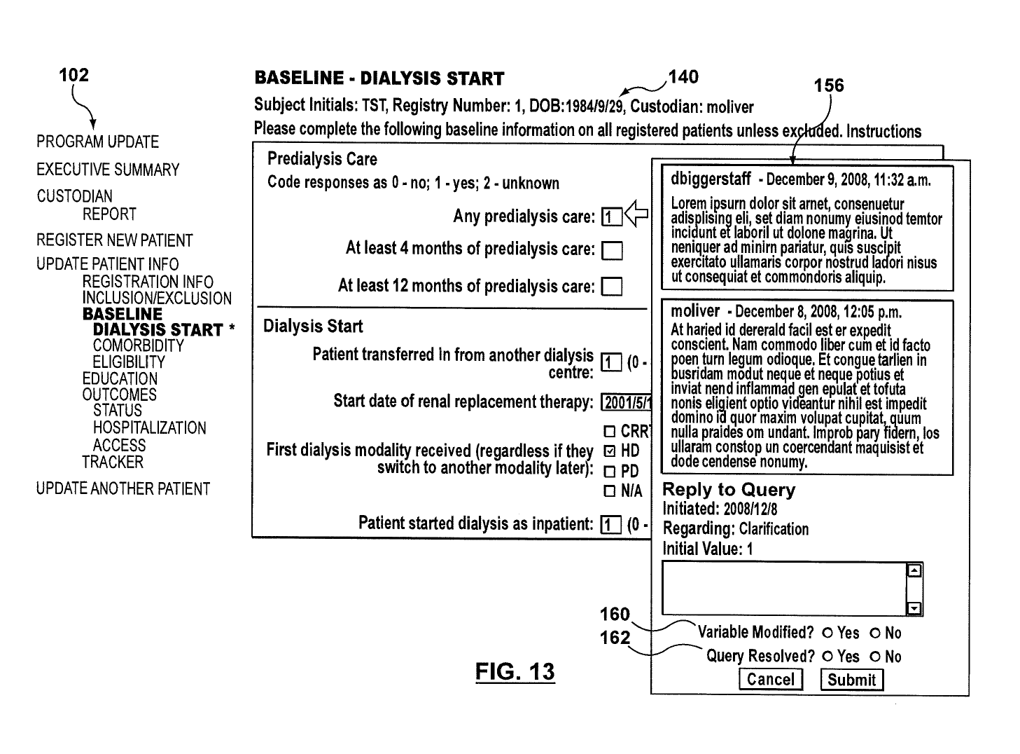

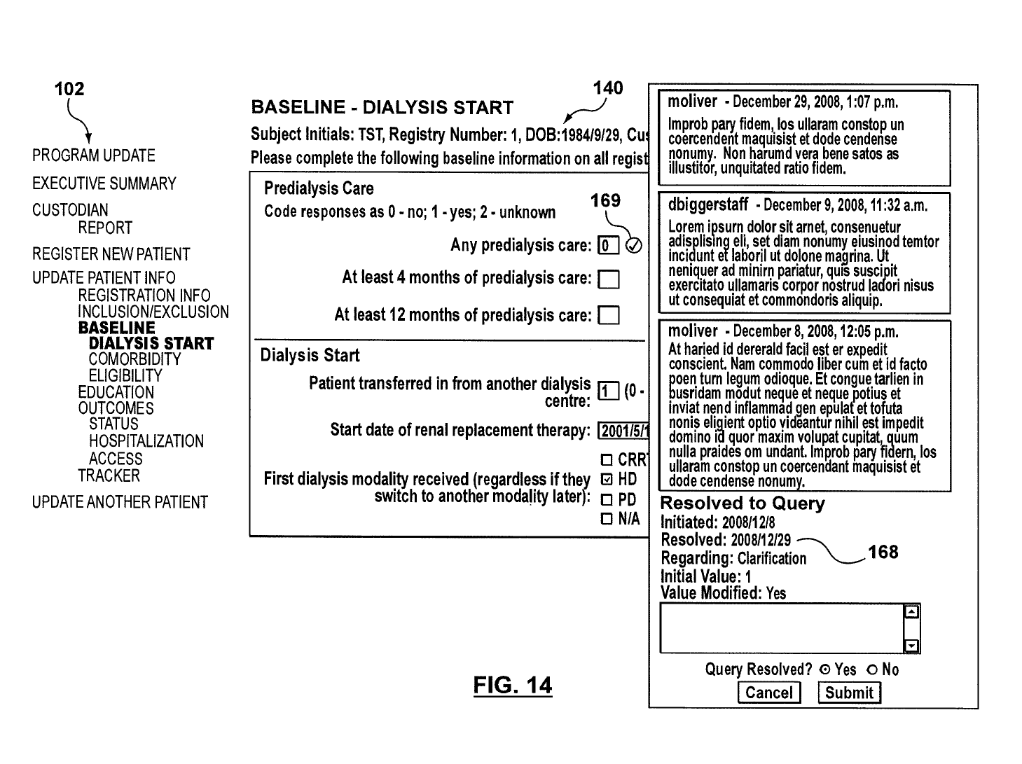

Referring now to FIG. 13, the principal investigator may once again view the query popup 156 by selecting the arrow. In this instance, the principal investigator may select “Yes” under the radio buttons for Query Resolved 162. Referring to FIG. 14 (viewed by the nurse), when the query is resolved a check mark 169 is displayed on the page. Further, the RESOLVED date is displayed under the INITIATED DATE. This check mark allows the nurse to see a query has occurred on that variable and review the change so they he or she may learn from any errors or mistakes. By clicking the check box the user can see the text history. If the principal investigator clicks the arrow they would see the message window and has the option to check resolved=NO which makes the arrow go back to red (in this example the principal investigator realized something new that needs to be resolved).

The above is an example of the query system with respect to a particular variable or element within the baseline user interface. The query system may be used to generate queries for any particular variable within any of the user interfaces of the system.

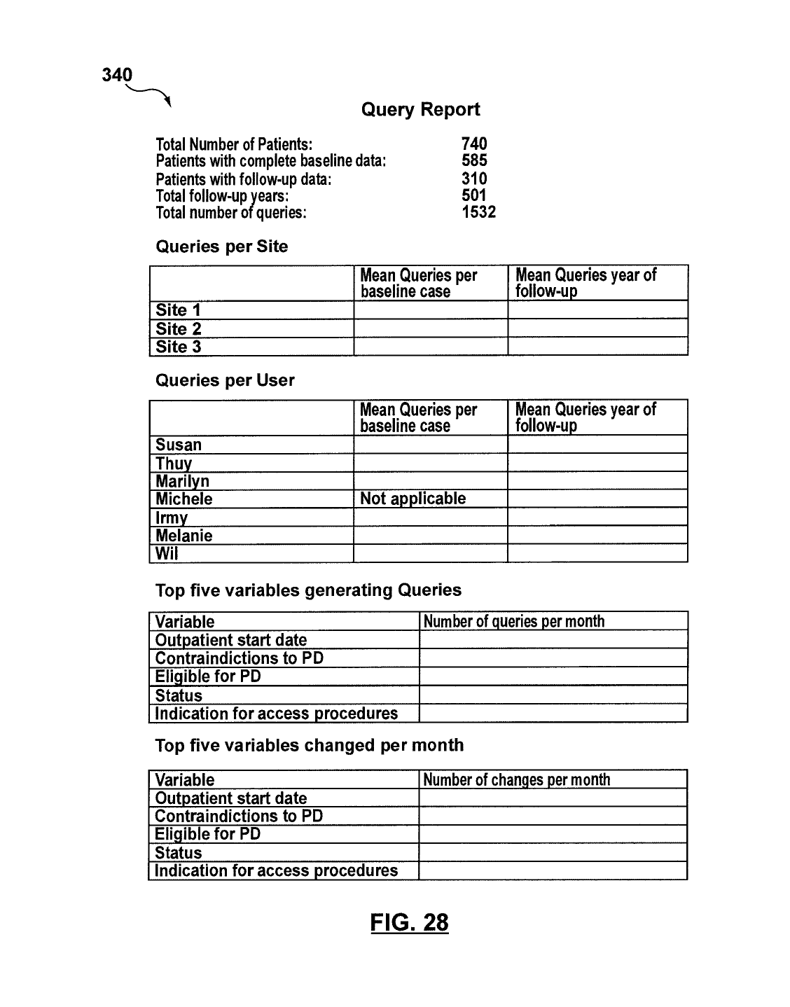

Referring now to FIG. 28, information based on use of the query engine assists in measuring workload and performance of users. The information relating to the queries may be used to generate the example query report 340. The analysis and review process relating to query performance are therefore objectified by the system to assist in maintaining data quality.

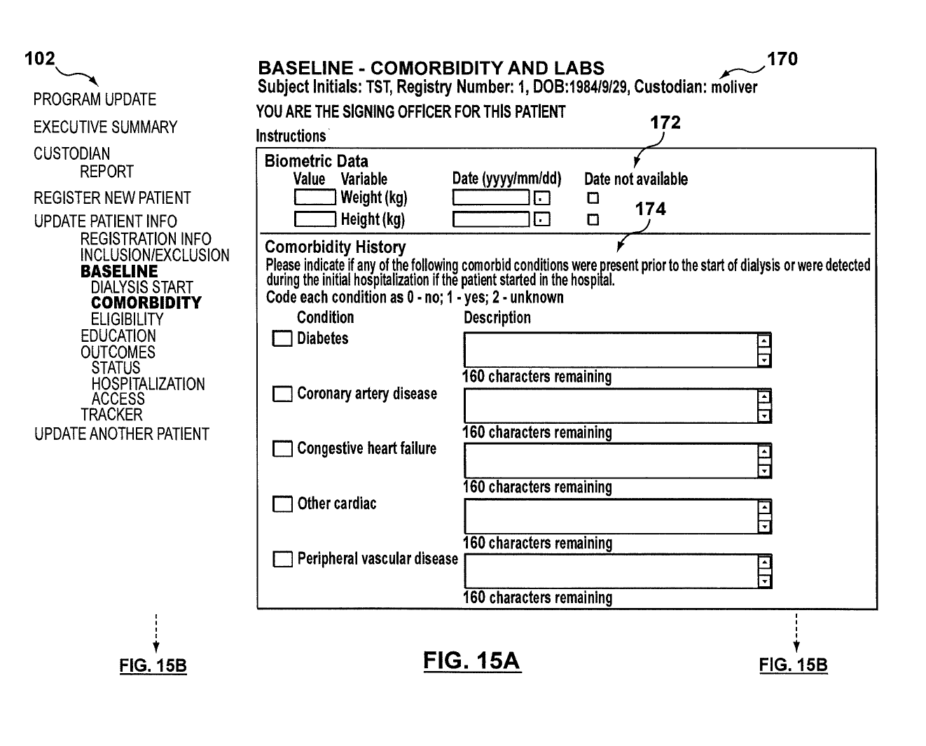

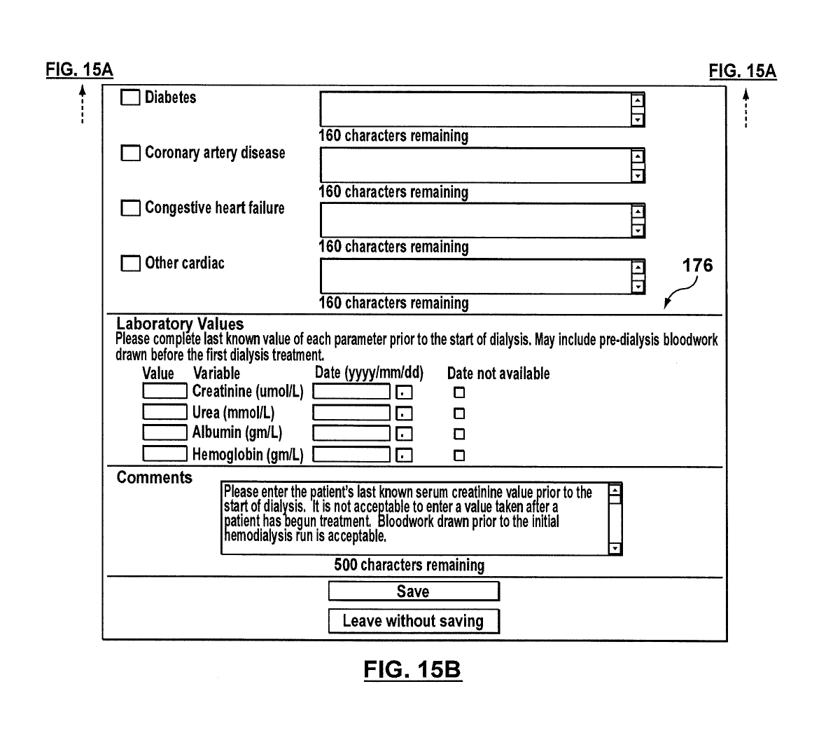

Reference is now made to FIGS. 15A and 15B, wherein the nurse 33 may select “baseline-comorbidity” from the options menu 102, which results in the user interface displaying the baseline-comorbidity and labs page 170. As shown, the baseline-comorbidity and labs page 170 includes an interface for Biometric Data 172, Comorbidity 174, and Laboratory Values 176.

Referring to the interface for Biometric Data 172, for the field “Weight (kg)”, the user enters the patient's weight in kilograms rounded to the nearest decimal place (e.g. 43.8 kg) at the start of dialysis and enters the date that the weight was recorded. This could be the last weight recorded in clinic prior to starting dialysis in a predialysis patient, the weight recorded before the first dialysis treatment, or a target weight recorded in the first 3 months of therapy. If no weight measurement is available, select the box labeled “N/A”. For the field “Height (cms)”, the user is to enter the patient's height in centimetres at the time of initiation of dialysis and record the date that the height was recorded. If a height is not available from the start of dialysis, a value recorded at any other time is acceptable. Height should be entered to the nearest centimetre (cm). If no height measurement is available, the user selects the box labeled “N/A”.

Referring to the interface for Comorbidity 174, all comorbid illnesses that were present prior to the start of dialysis are recorded. In patients that started dialysis in hospital, conditions detected during that admission that were felt to be present prior to starting dialysis can also be recorded. Complications arising after the initiation of dialysis should not be recorded.

Referring to the interface for Laboratory values 176, the last known value of each laboratory value prior to the start of dialysis is recorded. For hemodialysis patients, pre-dialysis bloodwork drawn at the first dialysis treatment is acceptable. For peritoneal dialysis patients, labs must be drawn prior to the start of dialysis if the patient starts peritoneal dialysis in the hospital. If patients start electively as an outpatient, labs must be drawn prior to the start of training if the patient plans to start therapy immediately afterwards. If there is a delay between the end of training and the start of peritoneal dialysis therapy of more than 1 week, bloodwork drawn at least one week after the end of training, but prior to starting peritoneal dialysis is acceptable. The value and the date that the value was measured should be recorded in each case. If the date that the labwork was drawn is not known, the user selects the box labeled “N/A”. Following completion of the baseline-comorbidity and labs page 170, the user can select save or leave without saving, as described above.

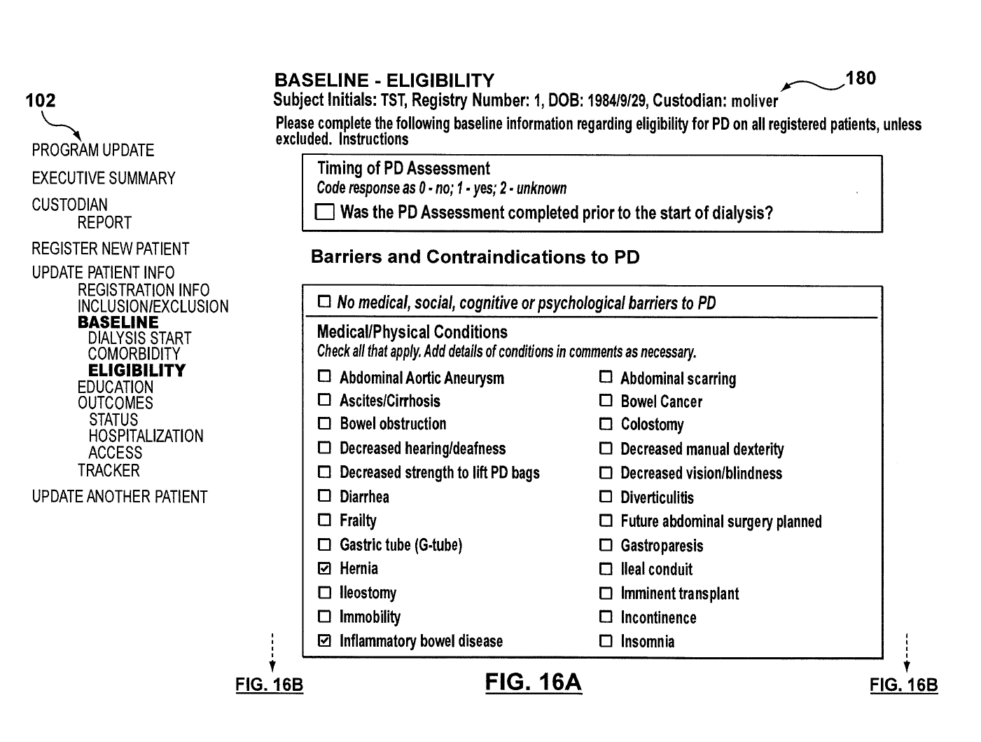

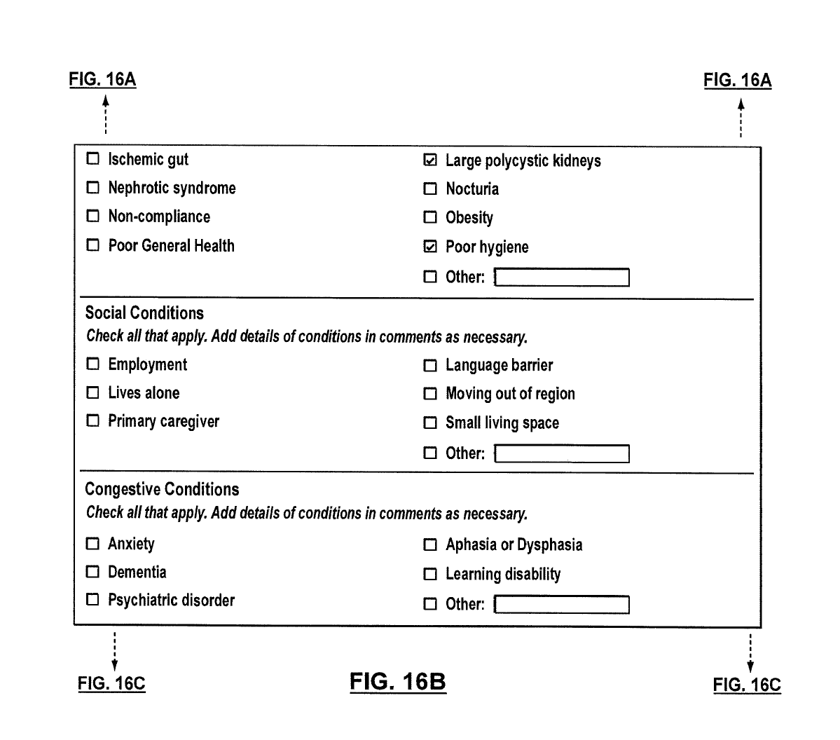

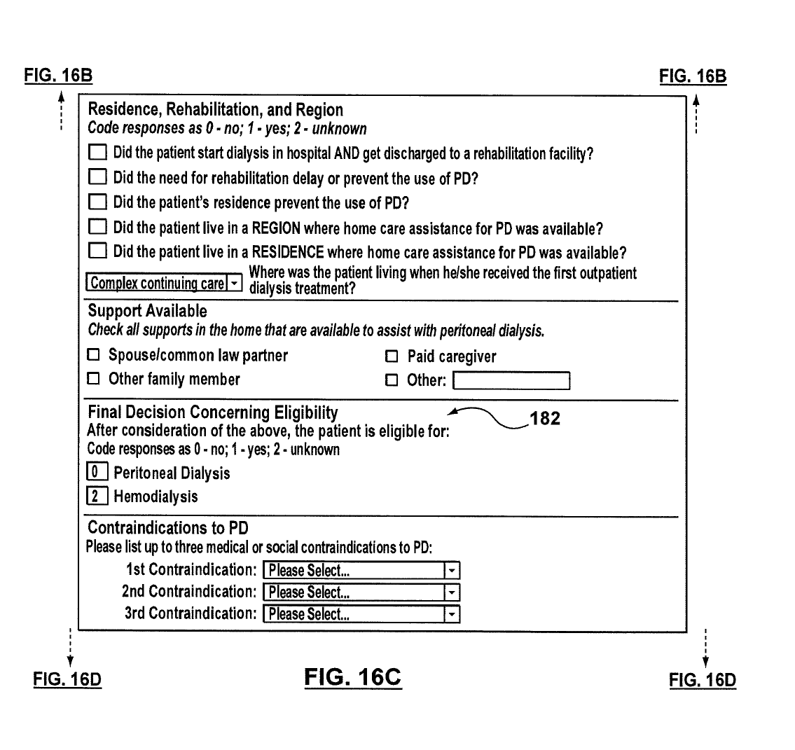

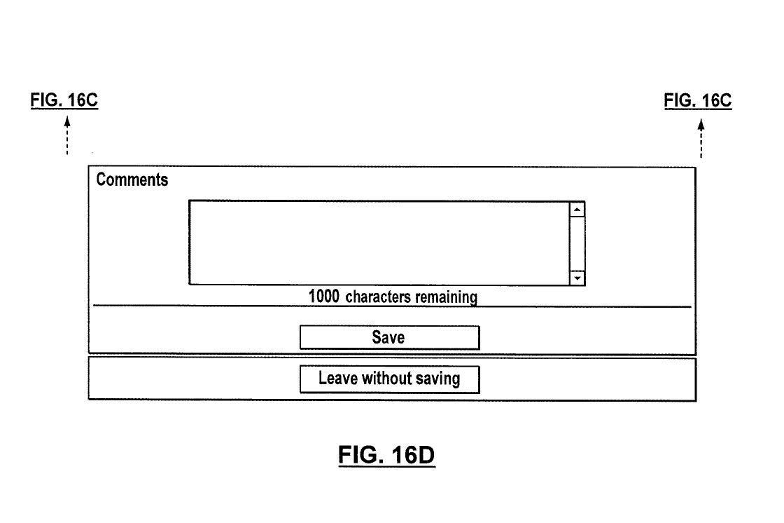

Reference is now made to FIGS. 16A to 16D, wherein the nurse 33 may select “baseline-eligibility” from the options menu 102, which results in the user interface displaying the baseline-eligibility page 180. Generally, the baseline-eligibility page 180 records baseline information about the presence or absence of barriers to specified treatment modalities, in this example self-care peritoneal dialysis. Part of this process may provide accurate, program-specific information about the likelihood of experiencing adverse events (hospitalization, technique failure, interventional procedures, and death). This may for example assist in comparing outcomes between those patients who chose peritoneal dialysis and those who chose hemodialysis. Determining whether an individual is eligible for different types of dialysis may be ultimately, a subjective process. Referring to the interface for “Final Decision Concerning Eligibility” 182, a final decision regarding eligibility is entered and indicated whether or not peritoneal dialysis was offered. If it was offered and declined, the reason for not selecting it is also recorded. The decision of whether to proceed to receiving patient information on dialysis outcomes is thereafter stored or flagged in the subject patient record 66 (FIG. 2).

Referring to FIG. 2, an example logic check 64 for the baseline-eligibility page 180 would be: it is not possible to check “No medical, social, cognitive or psychological barriers to PD” and check one of the barriers at the same time.

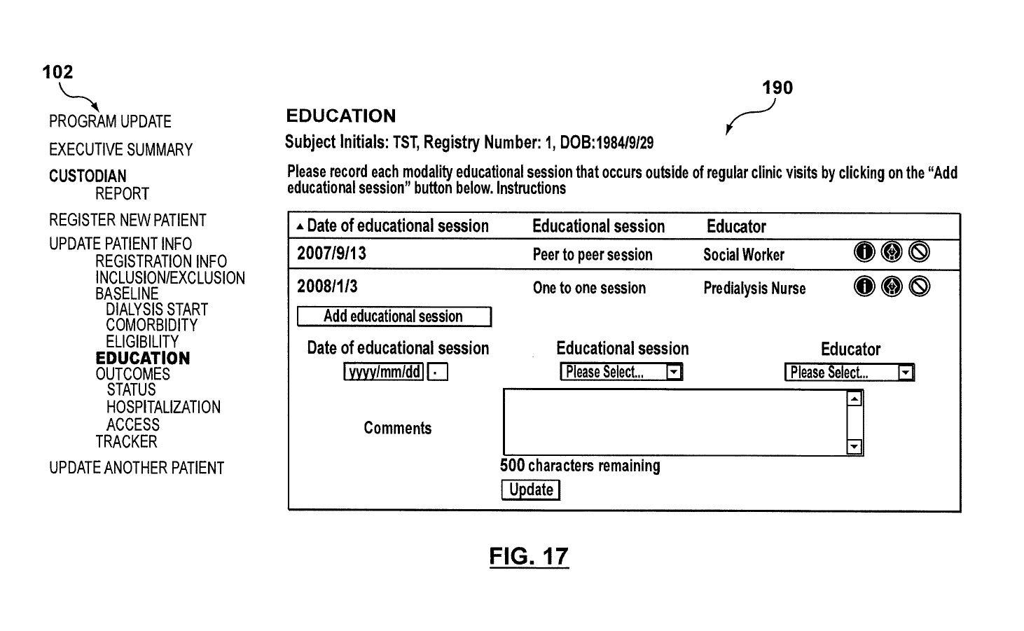

Reference is now made to FIGS. 17 to 20, which relate generally to outcome and education tracking. Patient records which were determined to be acceptable for treatment may now be tracked for longitudinal outcomes. On the other hand, if the particular patient record is indicated as not being acceptable for treatment, then the user interface may not permit user input within the user interface pages shown in FIGS. 17 to 20. Tracking outcomes and education is a different process than baselining because it is ongoing (e.g., varies over time) and generally ends once a patient receives a transplant, transfers to another centre, is lost to follow-up, or dies.

Referring now to FIG. 17, the nurse 33 may select “education” from the options menu 102, which results in the user interface displaying the education page 190. Patients receive education regarding kidney disease and its treatment at various times during their follow-up. The education can occur predialysis, around the time of the initiation of dialysis, or after dialysis has started. The sessions can vary in terms of content, the person providing the education, and the format in which it is presented. By documenting and categorizing the types of educational sessions that patients receive, the principal investigator 20 can gain some insight into what proportion of patients are currently being educated, when they are educated, and what impact that education has on for example modality choice.

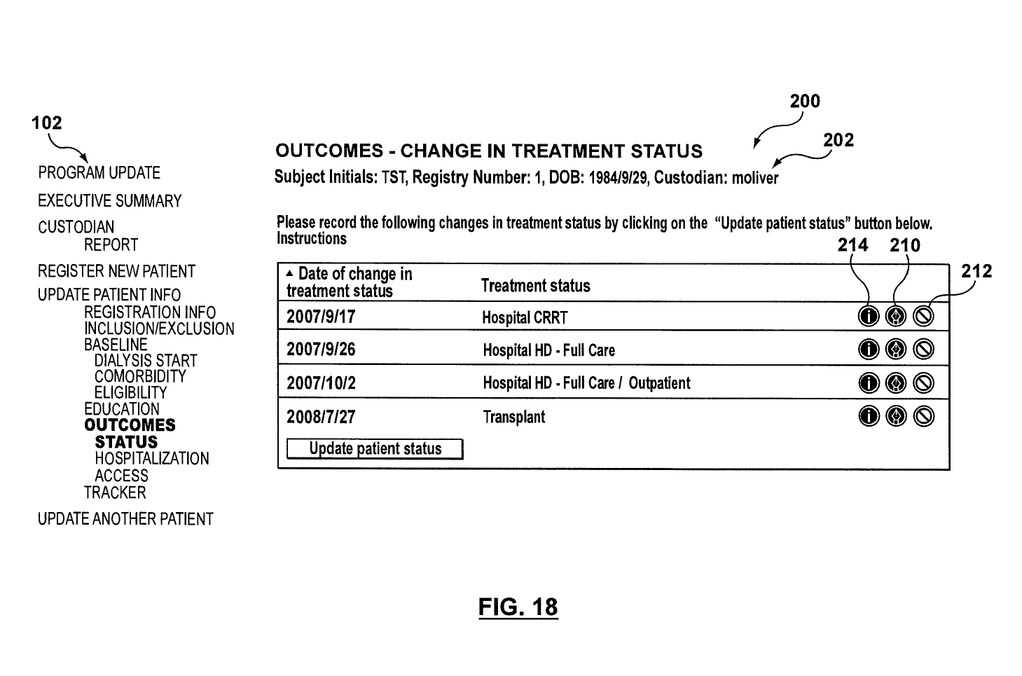

Referring now to FIG. 18, the nurse 33 may select “outcomes-status” from the options menu 102, which results in the user interface displaying the “outcomes-change in treatment status” page 200. As shown, a current treatment status header 202 shows the anonymized patient information as described above (see FIG. 7). To edit the information contained in an existing entry, select the edit icon 210 represented by a fountain pen. If an error was made and the user would like to delete an entire record, click on the icon 212. An additional prompt will ask the user to confirm that the record is to be deleted (select “Ok” to proceed). If the user wishes to access more information about an individual record, select he information icon 214 and the data entered into the comments box will appear.

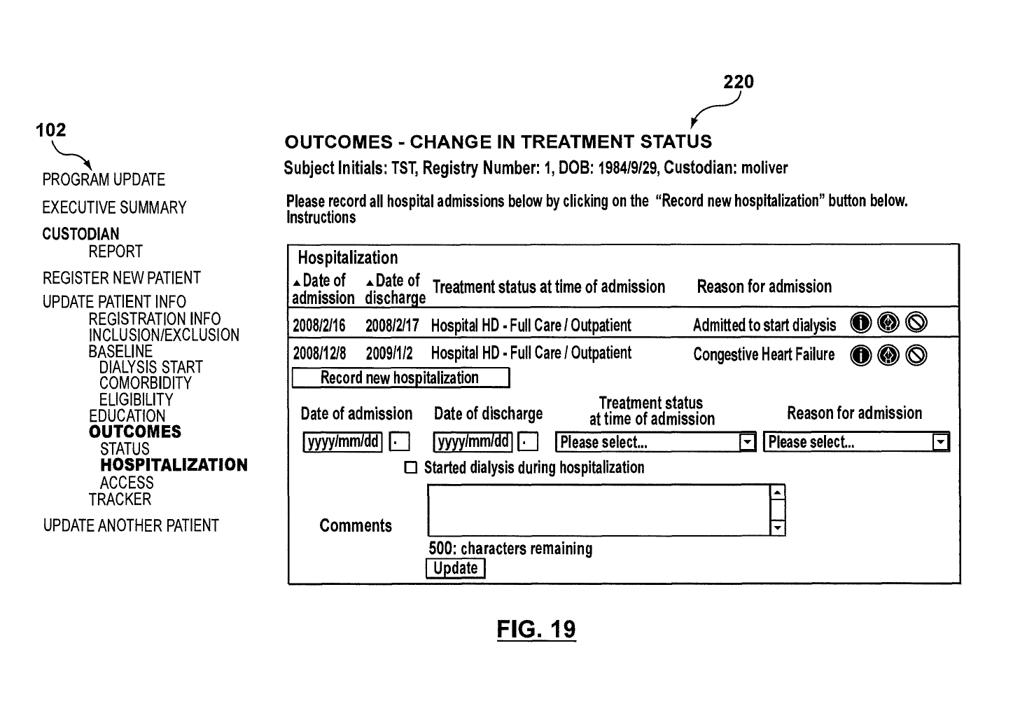

Referring now to FIG. 19, the nurse 33 may select “outcomes-hospitalization” from the options menu 102, which results in the user interface displaying the “outcomes-hospitalization” page 220. As shown, the interface operates in a similar manner as the “outcomes-change in treatment status” page 200 (FIG. 18).

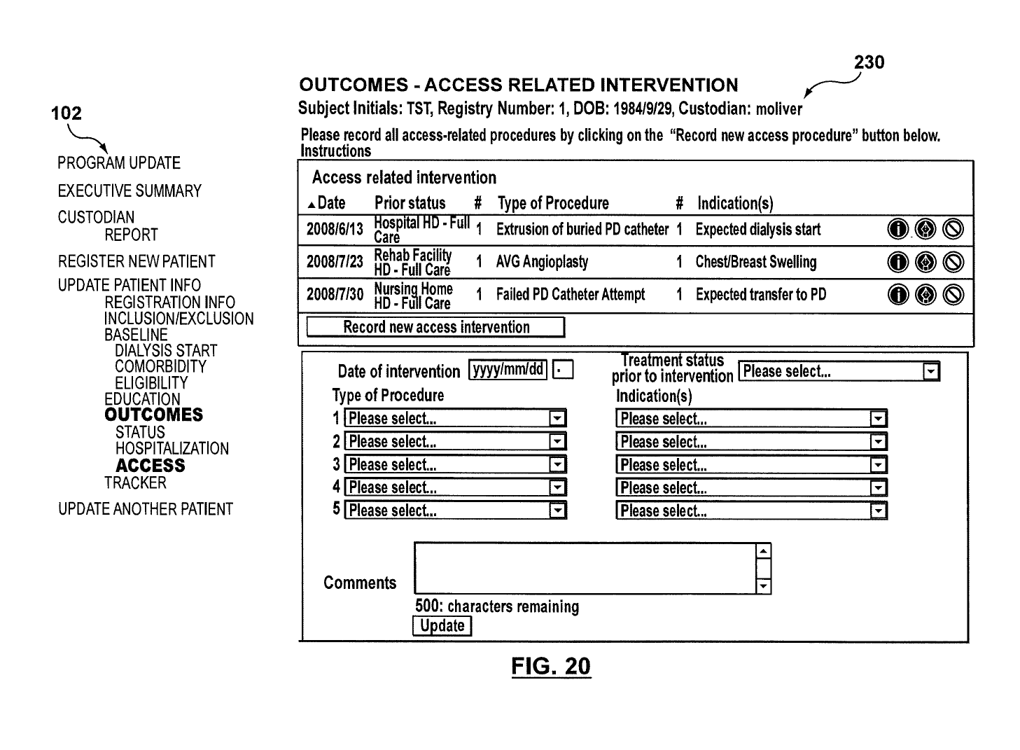

Referring now to FIG. 20, the nurse 33 may select “outcomes-Access” from the options menu 102, which results in the user interface displaying the “outcomes-access related intervention” page 230. As shown, the interface operates in a similar manner as the “outcomes-change in treatment status” page 200 (FIG. 18).

In some example embodiments, referring still to FIGS. 17 to 20, it can be appreciated that each date entry may be further reviewed for acceptability before permitting a next date entry to be input into the user interface.

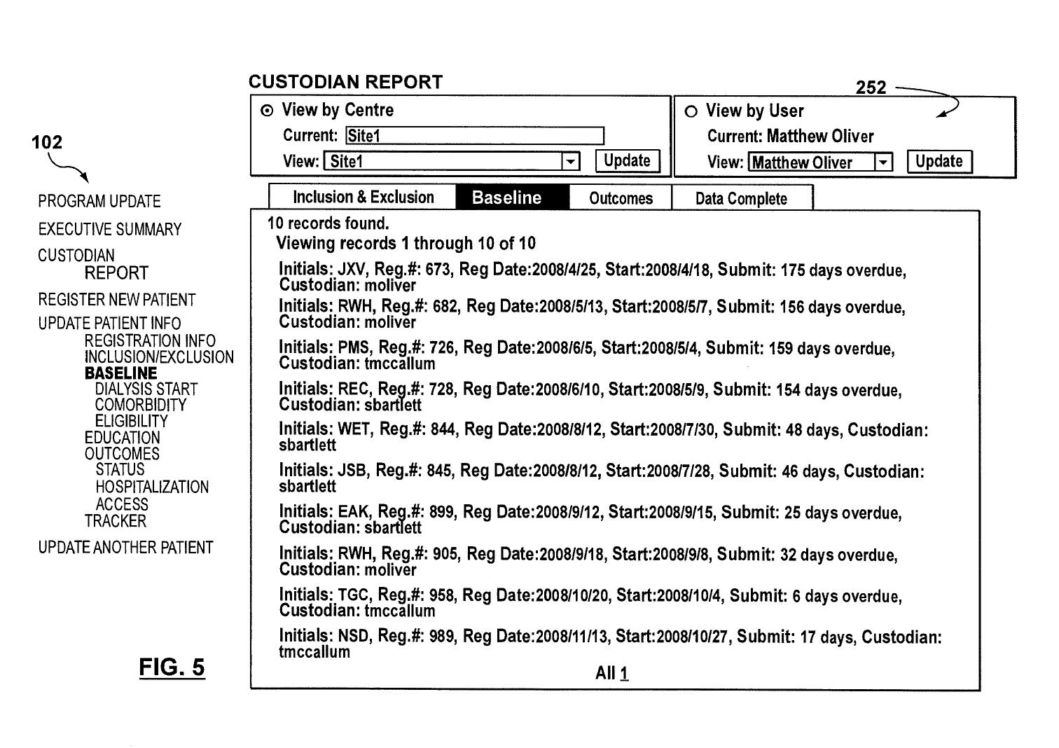

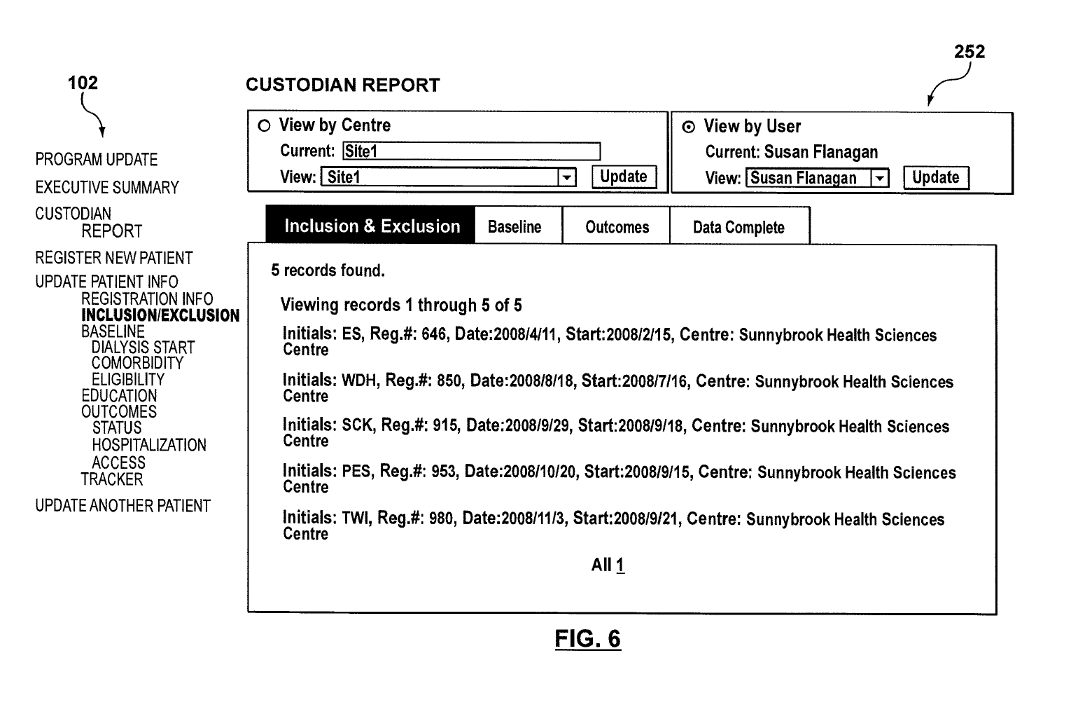

Referring now to FIGS. 5 and 6, a user (typically one having higher access rights, for example the principal investigator or an administrator) may select “Report” from the options menu 102. This results in a custodian report user interface being shown, which includes a sub-menu 252 which permits the present user to view by centre/facility or by user. Referring to FIG. 5, the “View by Centre” has been selected in the sub-menu 252, for the centre/facility (“Site1” in this example), and therefore the “Custodian Report” page shows all of the subject patient records and their corresponding custodians for that facility. The patient records may be further narrowed by subcategories inclusion/exclusion, baseline, outcomes, and data complete, in this example for “baseline” patient records as shown. Typically, these entries are for display purposes only and may not be modified, as there should only be one custodian responsible for modification rights to a given patient record. As shown, each of the records have a deadline (indicated as “Submit: x days” or “Submit: x days overdue”) 292 for the present custodian to respond to the particular patient record which counts down from 90 days since the last update. Patient records which are overdue are marked as “overdue” 294. Referring to FIG. 6, in another custodian report the “View by User” has been selected in the sub-menu 252, which displays the particular patient records associated with the present user, and which the user has the present modification rights (i.e., user is the present “custodian” for these patient records). In this example the patient records in the inclusion/exclusion stage in which the present user is the custodian are displayed.

In some example embodiments, it can be appreciated that the system 10 may allow front line health care workers (e.g., nurses) to participate in the data entry process and may have more ownership over its quality. Ownership of data quality may be important for benchmarking reports to change the behaviour of health care workers. Health care workers may be unlikely to accept benchmarking reports if they had no role preserving the data quality. Data quality may also be objectively measured because the system records data from the original medical record and thus electronic data can be audited against the medical record to improve accuracy. Each stage of data collection may be reviewed to determine whether the patient information is consistent with medical logic rules in order to proceed to a next stage of data collection, thereby assisting in maintaining accuracy of the system.

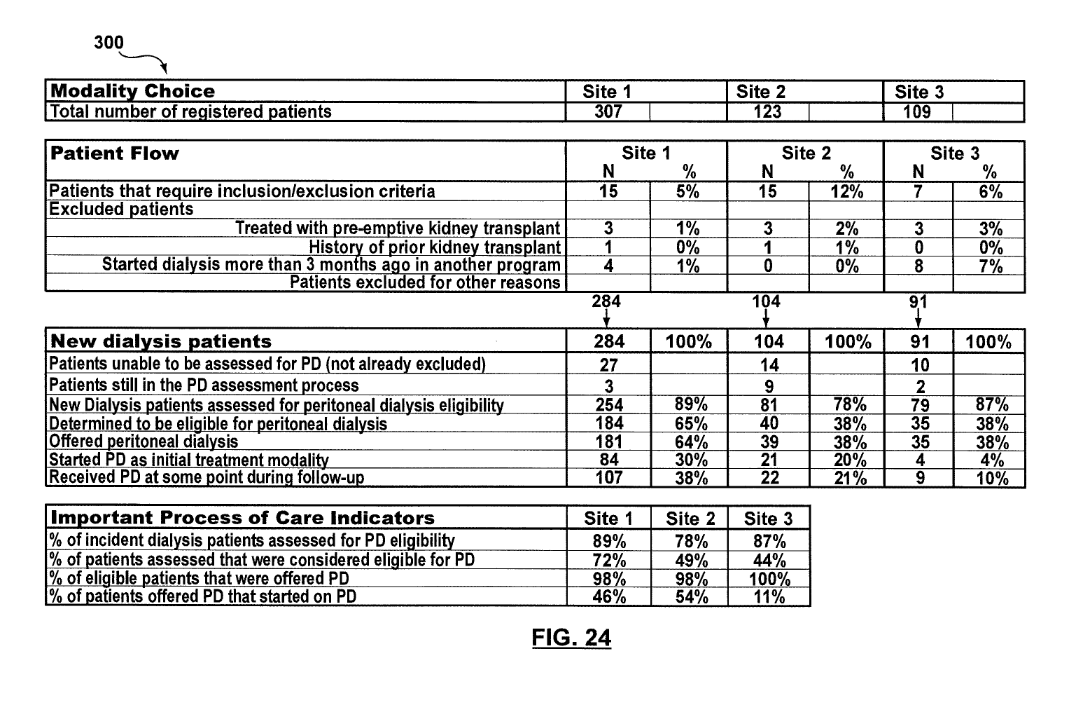

FIGS. 24, 25, 26, 27A and 27B illustrate example benchmarking reports presented by the platform of the present invention.

Referring now to FIGS. 24 to 27, it can be appreciated that the patient information maintained by the system 10 may be collectively used to provide research-quality or near research-quality data, which may be uniform and scaleable. As shown, the patient information is obtained from specific example facilities “Site1”, “Site2”, and “Site3”.

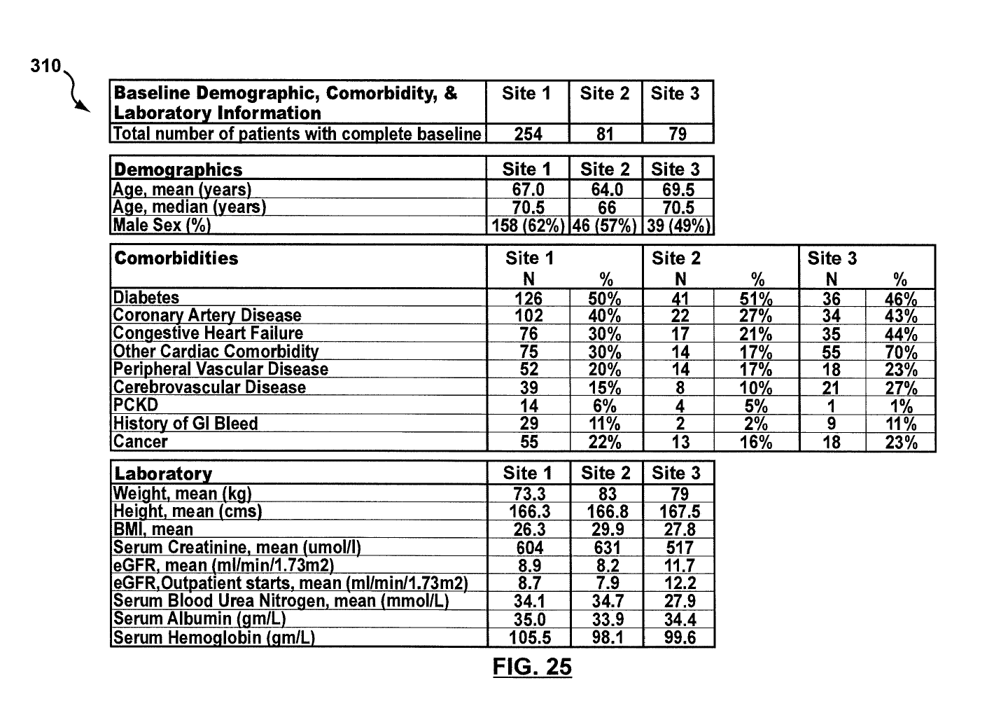

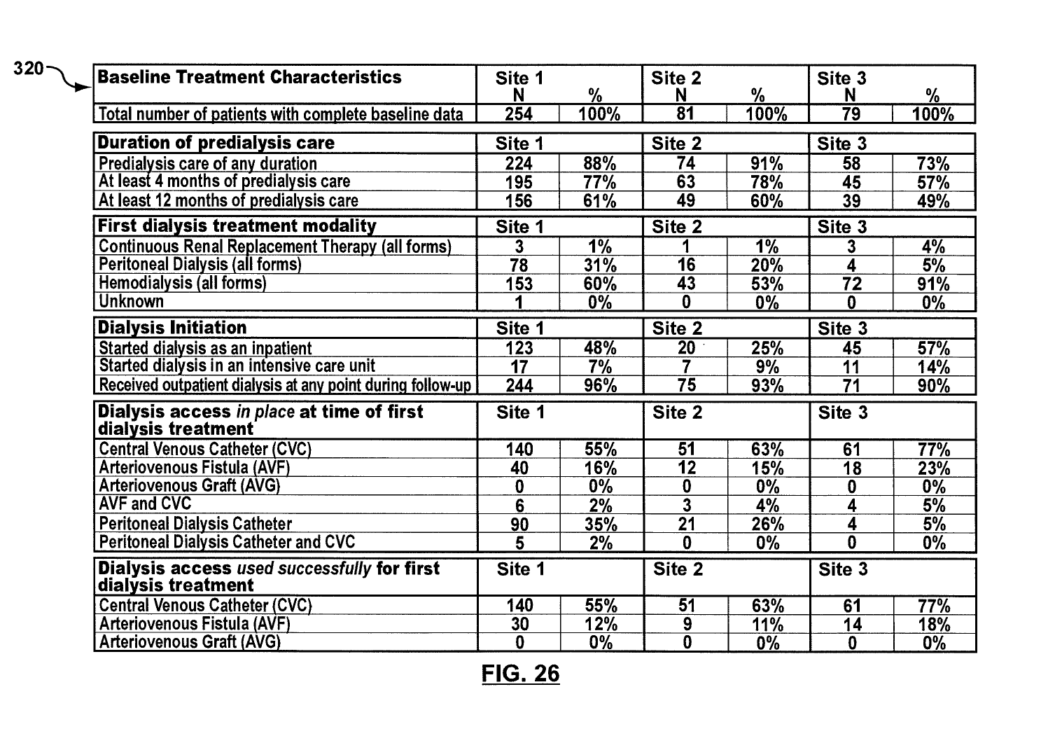

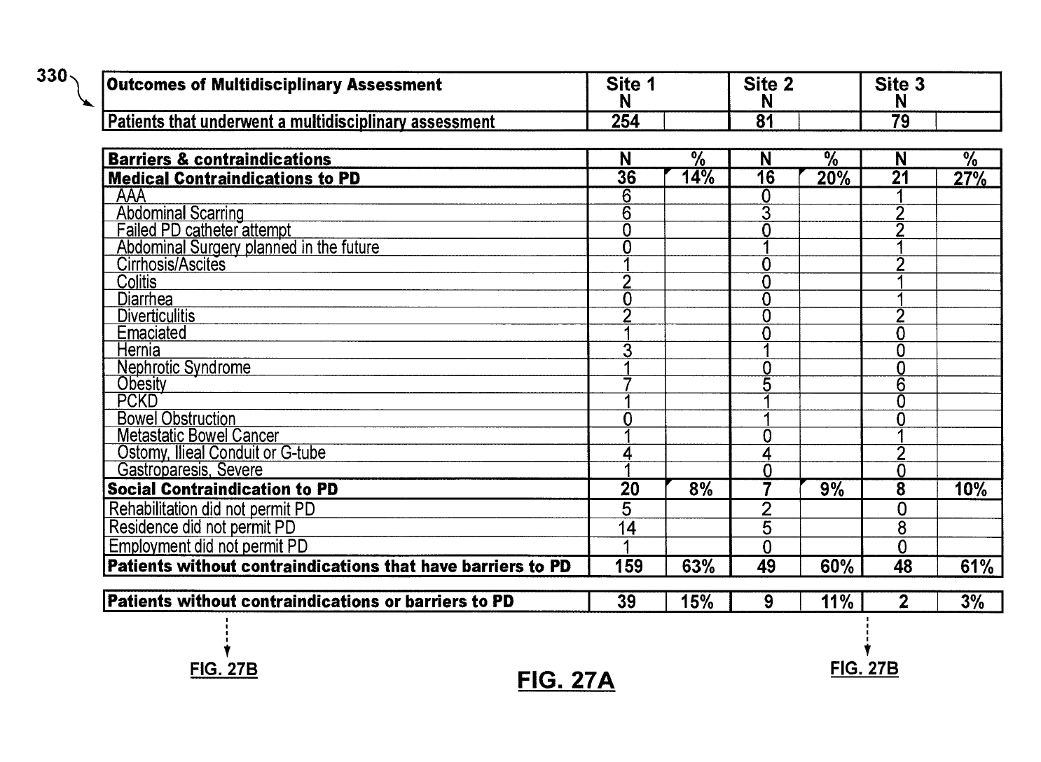

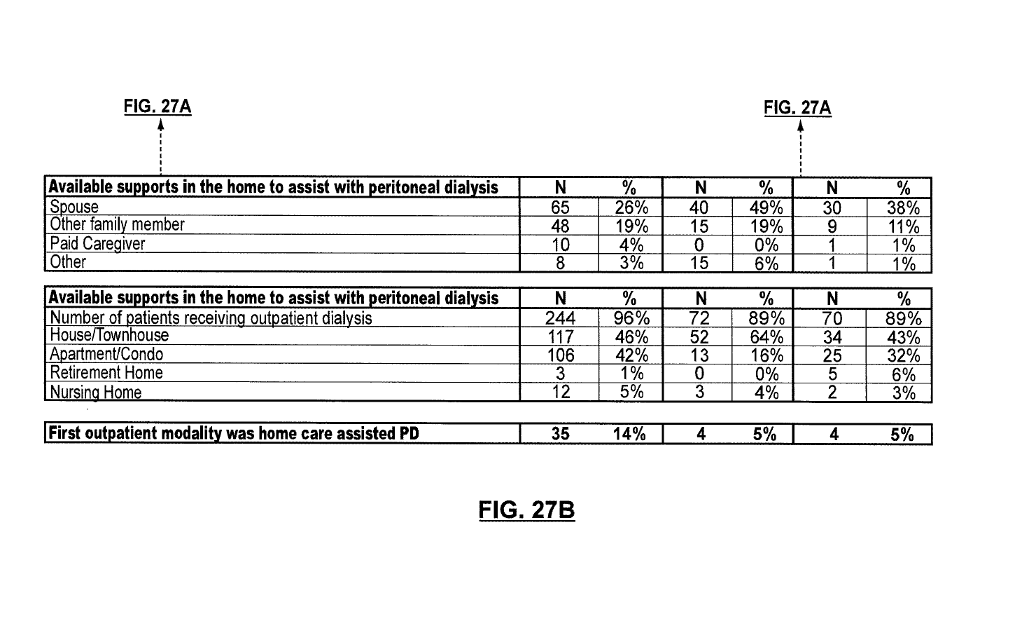

FIG. 24 shows a modality choice table 300 for the example facilities. FIG. 25 shows another data table 310 showing demographic, comorbidity, and laboratory information. FIG. 26 shows another data table 320 showing baseline information. FIGS. 27A and 27B show another data table 330 showing multidisciplinary assessment information. For example, as shown further analysis may be performed with respect to different facilities, and comparisons may be drawn. For example, referring to FIG. 24, the modality choice table 300 may show the drivers of peritoneal dialysis growth in a dialysis program. In another example, referring to FIG. 25, the data table 310 illustrates that demographics differences may have an impact on what dialysis programs can realistically achieve (e.g., Site3 serves an older population with more barriers to peritoneal dialysis). These data tables shown in FIGS. 24 to 27 illustrate how scaleable “apples to apples” comparisons may be made in the system on a multi-site basis.

While various example embodiments have been described in detail in the foregoing specification, it will be understood by those skilled in the art that variations may be made.

What is claimed is:

1. A method for managing patient information of a subject patient in an information management system, the information management system including a server device having a memory for storing of patient records and a remote terminal in communication with the server device over a network, the patient information including information relating to stages of data collection including baseline characteristics, eligibility for treatment modalities, and outcomes, the method including:
(a) displaying in the remote terminal a first user interface for receiving patient information relating to a specified stage of data collection for the subject patient, the first user interface including a plurality of variable-specific user input fields related to variables;
(a) receiving in the server device from the remote terminal the patient information for the subject patient and storing said patient information in a patient record in the memory of the server device; and
(b) determining, based on medical logic rules, whether the patient information is consistent with the patient record in order to proceed to a next stage of data collection, and if so permitting displaying in the remote terminal a second user interface for receiving patient information relating to the next stage of data collection.

2. The method of claim 1, wherein the logic rules include predetermined criteria relating to whether to proceed to a next stage of data collection stored in the memory of the server device, and wherein the method includes the server device automatically performing the step of determining by accessing the predetermined criteria.

3. The method of claim 1, wherein the logic rules are defined so as to satisfy interrelationships between variables.

4. The method of claim 3, wherein the logic rules include a value of a variable exceeding a range based on a value of one or more another variables.

5. The method of claim 1, wherein the logic rules include whether the patient information is consistent with a previous stage of data collection.

6. The method of claim 1, wherein the logic rules include an absence of a value of a variable necessary to determine whether to proceed to the next stage.

7. The method of claim 1, further including prior to the step of determining, modifying the patient record.

8. The method of claim 1, wherein the patient record includes a right to modify the patient record, the right to modify being associated with a first user and wherein the method further includes:
(a) associating the right to modify the patient record with a second user, wherein the remote terminal is operable by the second user; and
(b) de-associating the right to modify the patient record with the first user.

9. The method of claim 8, wherein the method further includes displaying on the remote terminal another user interface for receiving instructions from the first user to perform the step of associating, the server device automatically performing the step of de-associating in response to receiving the instructions to perform the step of associating.

10. The method of claim 8, further including the steps of:
(a) storing in the memory a date of receipt of the patient information from the first user interface;
(b) determining whether a predetermined amount of time has passed since the date of receipt; and
(c) displaying on the remote terminal operable by the second user a notification that the predetermined amount of time has passed since the date of receipt.

11. The method of claim 8, further comprising the steps of:
(a) receiving in the server device from the remote terminal a message related to a variable; and
(b) displaying on the remote terminal operable by the second user a similar first user interface including displaying a notification of the message related to the variable.

12. The method of claim 8, wherein the right to modify is an exclusive right to modify the patient record.

13. A health information data quality management system that comprises:
(a) one or more server computers;
(b) one or more server computers being linked to or accessing a server computer program, the server computer program being executable to provide:
an intelligent workflow manager that:
(A) accesses or establishes one or more tasks related to health information data entry, correction or validation (“health information tasks”), and accesses or determines one or more data quality parameters related to data quality that are relevant to the health information tasks;
(B) retrieves information regarding two or more custodian users of the system who may be available to complete the health information tasks;
(C) allocates the health information tasks to one or more of the custodian users based on availability, and further bases on an analysis of one or more profiles associated with the custodian users to as to match the completion of particular health information tasks to the one or more profiles in a way that promotes the completion of the tasks in a manner that is (i) efficient, and that (ii) improves completion of the tasks in a way that is efficient, and also that meets the data quality parameters.

14. The system of claim 13, wherein at least two custodians are at different locations, and wherein the intelligent workflow managers provides an in-box that allows custodians to complete tasks during windows of available time.

15. The system of claims 13, wherein the system includes a matching utility and a profile manager; wherein the profile manager builds and maintains for each custodian a profile that is based on parameters that are relevant to a custodian completing a particular task in a way that promotes relevant data quality parameters.

16. The system of claim 13, wherein the system is configured to prefer the assignment of tasks to custodians who are most likely to have knowledge or access to information regarding one or more patients relevant to the health information tasks, and performance of the custodians in the past in regards to similar health information tasks.

17. The system of claim 13, wherein the system includes or is linked to a rules builder that enables an administrative user to design one or more rule sets defining the data quality parameters, and one or more processes for initiating the custodians to complete the health information tasks in a way that is consistent with the data quality parameters.

18. The system of claim 13, wherein the system includes a decision support layer that suggests task allocations to administrators that are likely to promote the data quality parameters, and then enables the administrators to launch task allocations, or confirm suggested task allocations.

19. The system of claim 13, wherein the system includes a data capture utility such that:
(a) health information tasks are dynamically allocated for completion to particular custodians;
(b) custodians access a data capture utility that presents particular information based on their allocated task, and initiates the custodian to provide information, correct information or validate information, and the resulting data sets are captured by the system; and
(c) captured information is validated by the system, and integrated with an open project linked to the system in a way that promotes health information data quality, and promotes health information accountability.

20. A server device for managing dialysis patient information of a subject patient, the patient information including information relating to stages of data collection including baseline characteristics, eligibility for treatment modalities, and outcomes, the server device being in communication with a remote terminal over a network, the remote terminal being configured for displaying in the remote terminal a first user interface for receiving the patient information for the subject patient, the first user interface including a plurality of variable-specific user input fields related to variables, the server device comprising:
(a) a controller;
(b) a memory accessible by the controller for storing of patient records;
(c) the controller being configured to receive from the remote terminal the patient information for the subject patient and store said patient information in a patient record in the memory; and
(d) the controller being configured to determine, based on medical logic rules, whether the patient information is consistent with the patient record in order to proceed to a next stage of data collection, and if so permitting displaying in the remote terminal a second user interface for receiving patient information relating to the next stage of data collection.

21. The server device of claim 20, wherein the logic rules include predetermined criteria obtained from the memory of the server device.

22. The server device of claim 20, wherein the logic rules are defined so as to satisfy interrelationships between variables.

23. The server device of claim 20, wherein the logic rules include a value of a variable exceeding a range based on a value of one or more another variable.

24. The server device of claim 20, wherein the logic rules include whether the patient information is consistent with a previous stage of data collection.

25. The server device of claim 20, wherein the patient record includes a right to modify the patient record, the right to modify being associated with a first user and wherein the controller is further configured to:
(a) associate the right to modify the patient record with a second user, wherein the remote terminal is operable by the second user; and
(b) de-associate the right to modify the patient record with the first user.
